(19) United States
(12) Patent Application Publication
(10) Pub. No.: US 2001/0054004 A1
(43) Pub. Date: Dec. 20, 2001

(54) Method of direct communication between a business and its customers

(76) Inventor: Arthur C. Powers, New York, NY (US)

Correspondence Address: Myron Cohen, Esq., Cohen, Pontani, Lieberman & Pavane, Suite 1210, 551 Fifth Avenue, New York, NY, 10176, US

(21) Appl. No.: 09/876,687

(22) Filed: Jun. 7, 2001

Related U.S. Application Data
(63) Continuation-in-part of application No. 60/209,923, filed on Jun. 7, 2000.

(51) Int. Cl. G06F 17/60

(52) U.S. Cl. 705/14; 705/10

(57) ABSTRACT

A business model, system, and method for a business entity to distribute branding, advertising, marketing, and service (BAMS) data to consumer-users is described. The business entity establishes and maintains a venture server that transmits BAMS data to client applications installed on the electronic devices of consumer-users and controls usage and display of the BAMS data at the electronic devices. The client application, which is prepared and assigned a unique identifier by the business entity, performs a useful function that requires a graphical user interface (GUI) to be displayed in the display of the user's electronic device. After receiving the BAMS data, the client application stores it, and displays it in the GUI. The client application can be written so that no user information is transmitted from the electronic device to the venture server.

### RELATED APPLICATIONS

This application claims priority from U.S. Provisional Patent Application Ser. No. 60/209,923 which was filed on Jun. 7, 2000.

### BACKGROUND OF THE INVENTION

1. Field of the Invention

This invention relates to a method of doing business by establishing communications between a business and its customers through the use of original software distributed by the business.

2. Description of the Related Art

Businesses advertise and market their services to existing customers and prospective customers using various media, including traditional print and broadcast media, printed brochures, and, more recently, the Internet. Seeking to create business advantage in a burgeoning distribution network, the Internet, many businesses have developed “Web sites,” which are collections of Internet addresses related either by business interest or purpose where a business typically posts marketing materials and other information. In some cases, businesses endeavor to establish the “Web site” as a point of purchase. In nearly every case, attempts to attract and draw both customers and prospects to productive, profitable use of a Web site have proven futile.

a. Business Value

Corporate strategies prevalent on the World Wide Web (“WWW”) platform seek to create increases in business value through increases in the market prices of publicly-sold shares. The strategy has produced successes for, statistically described, a small number of dot.com business platform companies although media coverage of the market events cast an image of great success in the WWW platform businesses announcements. However, business operations have not generally been successful on the WWW platform. The business model in use by every business currently operating on the “Web” has, to date, produced substantive losses for nearly every business venture launched on the platform. Red ink is the rule, not the exception. An improved business model is needed. The subject business model of the present invention and software for practicing the invention presents such an improved business model.

b. Navigation Among Computers on the World Wide Web

The placement of random advertisements and other efforts to reach customers made by businesses to the WWW customer community on the Internet, and resulting ineffective reach to a customer is an important pervasive and perplexing shortcoming of the business model architecture in current use on the platform. “Stop by our web site” is an invitation often seen or heard from businesses operating on the platform. To act upon the invitation, a customer or prospect must manually input addresses to navigate the WWW in order to avail himself of access to information or services offered by a company.

The process of acquiring and using a WWW address is tedious and rife with opportunities to make a frustrating mistake. The unfamiliar alphanumeric jumble of a World Wide Web address is difficult to manipulate and read. Mis-assignment of one space in a WWW address renders it useless. The search task is a troublesome event and products of competing search facility companies are difficult to assess and evaluate. Popular search facilities—Google, Yahoo, and others—used to locate such addresses are themselves a confusing conglomeration of arcana. A simple search will often present dozens of “pages” of lists that a user must scan carefully in the effort to locate a general category of information. Following a winnowing of the returns, a search must be conducted through voluminous files of pages (each item with a nearly incomprehensible title) for desired information buried within. The navigation distracts the attention of a user from information that is desired and important to a current task, whether the information desired is needed for a business purpose, entertainment, intellectual pursuit, knowledge of consumer goods and services offered in the marketplace, or recreation.

A hypertext “Link” to a World Wide Web address which may be displayed on a WWW page or email often inserts another layer of distracting communication between the computer user and a desired address. The inserted communications layer may be populated by third party servers which may make invasive requests of the user's computer, and most often present third party advertising and other displays which distract a customer or prospect. Once the key “home page” address of a desired WWW address is located, the computer user must often navigate tediously through extraneous pages to discover or locate desired or pertinent information. The average “Web site” contains +/−450 “pages.”

Moreover, a user must also be equipped with the appropriate version of the Internet access software, the “browser,” or the user will not be able to access some or all of the aggregation of individual files, the “pages” of a web site. Improved tools for navigation and display of information are needed. The subject business model and software invention enables such navigation and display improvements.

c. Privacy

State Management Device (“SMD”) files, popularly known as “cookies,” are a critical and objectionable component of every WWW session conducted by every user because, as used in the WWW business model prevalent now, they infringe upon individual privacy rights. The term “cookie” is a popular-language term that masks and obfuscates the invasive business-purpose use of the State Management Device file.

The SMD is an instruction-set first designed for technological, not business-purpose use, and adapted to the invasive use now prevalent on the WWW. The HyperText Transfer Protocol (HTTP) used on the World Wide Web does not maintain a continuous dialog between a server and a client. A cohesive exchange of information requires a method to associate multiple requests and exchanges between a server and a user-computer. The State Management Device file, the “cookie,” was established originally to associate disparate server requests in order to maintain a coherent connection between a server computer and a computer connected to the internet by a WWW access software. The SMD “cookie” file may also identify the user to the same server in future transactions. As used today, State Management Device files, “cookies,” are delivered over the WWW network from various servers to a user system, typically at the time the WWW access software, in popular parlance, the “browser,” queries a network server during navigation either through the general WWW space or through an aggregation of files posted at related Internet addresses known in popular parlance as a “Web site.” A Web site is a collection of files grouped and related by corporate or personal interests

Web “browser” offers a user the option to: 1. accept all SMD files, “cookies,” 2. refuse all cookies, or 3. notify a user of the wish of a server to set a cookie, an SMD file. The default setting on WWW access software is “accept all cookies.” “Cookies” are therefore often placed on the hard disk storage of user systems without knowledge of the user that a SMD file, a “cookie,” was received. A Web site typically sets more than thirty SMD files during a user session on a site. The executed “set cookie” request creates a serious privacy breach for users, and for businesses that wish to conduct business with customers in private, secure transactions. With preference option set for “notification,” upon notification of the attempt to deliver an SMD file, i.e, a “set cookie” request from a server, a user may elect either to accept or to deny the request of a server to set the SMD file. In some instances, a user may be denied permission to a WWW address or file if the “set cookie” request is denied.

As used today, SMD “cookie” files are most often deployed by third party contractors affiliated in temporal relationships with various servers visited by a computer user. Ignorant of fast and loose data mining business practices of businessmen engaged on the WWW platform and injurious ways in which the SMD files are employed, users often agree to “accept all cookies.” Data mined in analysis and scrutiny of cookies is used to detail and track WWW movement of a user; to discover and record the Internet addresses that a computer user has visited, and to further aggregate, collate and distill the data collected into personal profiles that identify a computer user and the user's private interests. The information developed can detail, reveal, and specify the most critically private personal information.

The tracking party, most often a third party, often an information reseller, may use the information collected and distilled to target the tracked and profiled user for purposes far outside the envelope of understanding of the transaction held by the user at the time the SMD file, the “cookie,” was initially placed; possibly, for nefarious purposes. The business model operated by most businesses on the WWW platform exposes every computer user to invasive practices which may be used to employ injurious practices. The platform needs a defensive tool with which every user may shield themselves from injury. The subject business model and software invention presents such a tool to shield every user.

d. Information Delivery

Businesses can attempt to communicate with their customers by email, though email presents pervasive technical disadvantages and significant aesthetic shortcomings if employed to display business advertising, branding, marketing and service messages, which is abbreviated below as “Bam!S”, among customers. A business may send text messages to email mailing lists either rented or owned, though graphic and multimedia files must be attached to the email and displayed, if opened, on an addressed computer by software other than an email application. The user is responsible to obtain various software that enables such extensions of use. The described limits—to text manipulation—set for email applications is an intentional simplification of email software made to ensure compatibility and ease of use among various available email software packages. Host and intersecting protocols are often changed, creating circumstances in which a computer user may not have software that can read, universally, incoming email messages. In addition, email applications are not designed or configured to enable full-time display of any file—graphic, text or otherwise. An email user interface is designed as a simple text editor and reader, not as a utility for facile display.

e. The Intersection of Aesthetic Criteria and Practical Reality In a Market Effort

From the perspective of the foundation need of a business to project an image of solidity, of trust deserved and earned, email is not a viable option for either a first magnitude or a small company concerned to project an image of value. Email advertisement and marketing messages are most often seen as “spam,” junk mail that fills the digital mailbox, most often used in the promotion of get-rich-quick-schemes and pornography. Empowered, thoughtful businessmen are not eager to display advertising and marketing business offerings in email along with and adjacent to the messages of “spammers” and pornography sellers. Of course there is a significant concern about privacy and security. Email is easily diverted, intercepted, and read by others. Management of first magnitude businesses are eager to find and embrace a digital communications method that enables cost effective, direct, secure, one-to-one dialog with customers and prospects. The subject business model and software invention enables such communications.

### SUMMARY OF THE INVENTION

It is an object of the present invention to establish and maintain a method of doing business wherein a business can privately and securely communicate with customers and prospective customers over the Internet without fear of intercession, intervention, or manipulation of the communications by third parties.

It is a further object of the invention to provide a business with a method of delivering information regarding products and services, and to encourage further use of products and services offered by the company.

It is a further object of the invention that the distributed software present convenience, privacy and utility features that attract a distributee-user to employ the software during every use of the computer system on which it is installed, ensuring that advertising, branding, marketing and service information delivered from a business to users will be frequently in view and effective. It is a further object of the invention to create a facile and versatile business model that establishes a menu of revenue opportunities in varied industries and economic circumstances.

These and other objects are accomplished by the business model, system and method according to the present invention. In one aspect, there is provided a system and method for a business entity to distribute branding, advertising, marketing, and service (BAMS) data to a client application on the electronic devices of consumer-users. The business entity establishes and maintains a venture server that transmits BAMS data to the client applications, and controls usage and display of the BAMS data at the electronic devices. The client application, which is prepared and assigned a unique identifier by the business entity, performs a useful function that requires a graphical user interface (GUI) to be displayed in the display of the user's electronic device. After receiving the BAMS data, the client application stores it, and displays it in the GUI.

Features of the present business model and software invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and unless otherwise indicated, drawings are merely intended to conceptually illustrate the structures and procedures described herein. The various features of novelty which characterize the invention are pointed out with particularity in the claims annexed to and forming a part of the disclosure.

### BRIEF DESCRIPTION OF THE DRAWINGS

In the drawings wherein like reference numerals denote similar elements throughout the several views:

FIG. 1 is a schematic representation of the interrelationship between the parties who participate in the business method of the present invention;

FIG. 2 is a block diagram of selected components of the computer system architecture on which the business method may be implemented;

FIG. 3 is a flow chart of the steps for practicing the business method of the present invention;

FIG. 4 is a printout of a sample opening screen for the client software, including a diary;

FIG. 5 is a printout of a diary screen with Bam!S messages superimposed thereon;

FIG. 6 is a printout of a “financial journal” screen for the client software;

FIG. 7 is a printout of a personal address directory screen with a record in the address directory selected;

FIG. 8 is a printout of the personal address directory screen with various co-branding and third party Bam!S messages displayed thereon;

FIG. 9 is a printout of the personal address directory screen with another record selected;

FIG. 10 is a printout of a business address directory screen where a car manufacturer (in the illustrated example, Buick®) is the Licensed Venture Entity and fields are available for entry of dealership information in the address directory by the manufacturer;

FIG. 11 is a printout of the screen of FIG. 10 with advertising written on a portion thereof;

FIG. 12 is a printout of the screen of FIG. 10 with the address directory fields replaced by an advertisement for Carolina First® Bank;

FIG. 13 is a printout of the address directory screen of FIG. 10 with an address directory record for a dealership selected and information fields for the selected dealership displayed;

FIG. 14 is a printout of the address directory screen with an address directory record for another dealership selected and a photo and specifications for a car model sold by the dealership;

FIG. 15 is a flow chart of an algorithm for one click database record linking incorporated into the client software;

FIG. 16 is a flow chart of an algorithm for sorting and searching multiple field address records incorporated into the client software;

FIG. 17 is a flow chart of an algorithm for WWW Document Address Mining and Storage for World Wide Web addresses incorporated into the client software;

FIG. 18 is a flow chart of an algorithm for manipulation of State Management Devices incorporated into the client software;

FIG. 19 is a flow chart of an algorithm for WWW Document Mining and Storage for documents posted on the World Wide Web incorporated into the client software;

FIG. 20 is a printout of a hospitality screen showing a sample listing for three establishments, including a Bam!S message for MasterCard®;

FIG. 21 is a printout of the hospitality screen showing a sample listing for three different establishments, including a list of rankings of various establishments;

FIG. 22 is a printout of the hospitality screen partially overlaid with an advertising screen for an establishment, including photographs and a menu; and

FIG. 23 is a printout of the hospitality screen partially overlaid with a reservations screen for sending a reservation to an establishment.

### DETAILED DESCRIPTION OF THE PRESENTLY PREFERRED EMBODIMENTS

The invention business model and software establish a method by which a business entity, a “Licensed Venture Entity”, may directly, privately, and securely communicate with its customers and prospective customers by use of an invention software product distributed in the market to actual or potential consumer-users. The invention software, a client application product that enables and facilitates the business model, is provided to established and prospective customers and other related persons or entities (the “distributee-user”) of a business entity affiliated with the Licensed Venture Entity. The software is distributed to either customers and related persons or entities (the “distributee-user”) who have either established or incipient relationships with the business entity. For example, the consumer-user may have purchased a product or service of the business entity. As used herein, the term “customers” (and “consumer-users”) includes prospective customers. The software may be compiled for different systems in order that versions of it may run in any electronic device (whether a personal computer, a laptop computer, a personal digital assistant, a cellular telephone. etc.). The invention software may be distributed with customer preferences relevant to the distributee-user written into the software product. Distribution criteria may employ customer relationship data already known to prepare and distribute a version of the software that is custom-configured to the distributee-user, including database information and advertising, branding, marketing and service (Barn!S) material files relevant to the business entity or affiliates and targeted to the distributee.

The Bam!S materials files prepared for distribution on the Venture Server can include graphics and text files. The files can be, but are not necessarily limited to, advertisements, branding and marketing materials which may be, for example, price lists, notices of either new or re-priced inventory, service bulletins and all types of documents and notices of importance to a customer service relationship. The transmission of Bam!S materials in this manner may obviate the need for a company to send customers and prospects a variety of informational materials by traditional channels, like surface mail. In addition, Bam!S material may comprise an electronic coupon, which may be downloaded by the user and either printed out or remain in computer-readable format.

The invention software is configured to receive delivery of Bam!S materials files, write the materials files to database storage and display the Bam!S files in future computer-use sessions of the distributee. The Bam!S files may be displayed at all times the distributee-user system is in use, regardless of whether or not the distributee-user system is connected to the Internet.

The software is outfitted with an array of application database utilities such as an address directory, a calendar, diary and planner, and financial journal, which are features and utilities that are typically employed by computer-user citizens every day. These useful features encourage and prompt a user to employ the software daily. The product provides assistance to a company customer or prospect with execution and completion of daily information seek (i.e. search), mining, storage and recall needs. Such assistance and use provides exposure of a customer or prospect to the Bam!S materials that are displayed while the software is loaded. The database array, configuration of the user access to the database and supple design of the user interface also enables entry, storage and recall of individual information files that provide each member of a family or affinity group with personal use, private utilities.

One or more Bam!S messages can be displayed in areas of every interface screen or screens for the address directory, diary and financial journal. As one example, the name, logo and slogan of the business venture that has distributed the software, as well as additional and affiliate branding messages, may be inserted into the Title Bar at the top of every screen. Advertisements, branding, marketing and service messages can appear on other areas of the screen in various locations, such as within a dedicated message field or fields of a multi-field screen; within another multi-function field when the field is not otherwise in use; written above unrelated information on a portion of the screen for a period of time known as “a rotation,” a designated display design that is time delimited; or until the user enters a keystroke or moves a pointing device on the interface. The display of Bam!S materials can alternatively be programmed to move around a user interface in a manner designed to either draw a user's attention, or a series of messages can be alternately displayed in one unobtrusive location on the screen.

Use of the invention client software enables the distributee-user to make a direct computer connection to a customer-specific Internet address (the term “customer-specific” and “user-specific” are used interchangeably) provided by the business entity on a server, the Venture Server, where additional customer-specific information, improvements to the software, serial editions and updates to the product may be available. Through use of the invention software, a direct and private communication link is established between a business and its customers and prospective customers. The customer-specific Internet address provided serves as a customer's direct, personal “portal” to information posted by the business on the Internet. It is therefore not necessary for a customer to navigate manually through the WWW to find the company address, or to “stop by” the Internet address of an associate business.

The Venture Server controls the delivery and display of all Bam!S materials by the Licensed Venture Entity. No third parties control the administration, placement or run time of delivery or display of a company's information that flows from a market company to its customers and prospects. Establishment of a supple communication between a company and its customer is a foundation element of good business practice. The direct communication method is cost effective, uncomplicated delivery and offers greatly expanded opportunity of access, study and use, by customers, of Bam!S information. In contrast, in business arrangements presently prevalent between companies who offer goods and services to entities that seek display, and the agents and third parties that create and distribute marketing materials and WWW businesses who deliver the materials, contact with a consumer customer or prospect is either controlled by or interceded upon by third parties who are various agencies and contractors that place themselves advantageously in the Internet communications conduit between a company and its customer.

Distribution of the invention software to customers and the associated, well-designed display of Bam!S materials provides service and enhances customer loyalty for all businesses and entities associated and identified with the invention software, particularly if the software is distributed at no charge to customers. The ability of the feature-laden invention software, possibly distributed free-of-charge, to deliver and display directory information and Bam!S materials in a familiar and trusted format further establishes comfort and customer loyalty to the invention software and affiliated companies. The core-use database utilities together with WWW navigation tools in the invention software provides service and establishes the software as a compelling presence in the day-to-day activities of a consumer/customer. Moreover, easy receipt of information and ready, repeated, uncomplicated access to pertinent advertising, branding and marketing and service information results in appreciation and continued accrual of good will to the Licensed Venture Entity. Moreover, the invention software offers the ability to easily complete and simplify financial and information gathering transactions by distributing and affiliate businesses. A capable, multifaceted product for revenue generation is created.

The Bam!S information display may include contact information for the Licensed Venture Entity, its various affiliated division and brand relatives, and various third party affiliates of the venture. The database information directory provided by the Licensed Venture Entity may be written to the invention software database at the time of the initial distribution of the software and can be updated over the Internet thereafter. Though the database configuration enables a user to create an unlimited number of database files, a user may store address directory and directory records from the Licensed Venture Entity in the same file so that only one file need be searched to locate a desired record. A specific Bam!S message may be linked to a particular record in the directory, such as a linking of market information for a certain model of car to an address directory record for a dealership where that car may be purchased. By recalling the address directory record, a user can view advertising, branding, marketing and service materials pertinent to the manufacturer, brand, and dealer. The functionality of the address directory is enhanced by configuration design of the address directory interface with numerous data entry fields and the ability to sort and search the fields independently.

An Internet address field in the address directory interface enables recordation of a WWW address and indexing of the recorded Internet address in the address directory. The WWW address can then be written, in response to a click command, to WWW browser software, thus directing the WWW software to query and establish a connection with the WWW address selected.

The invention software also offers a “World Wide Web Address Mining, Storage, and Recall” utility that is a feature intended to ease navigation, storage, and recall tasks needed by distributee-users, and to lead users to more frequent use of the invention software and BAM!S information. By issuance of a “one click command” to the invention client software interface, or to a dedicated icon written to and displayed in the Microsoft Windows System Tray in the Windows Task Bar, a distributee-user mines the WWW access software (“browser”), captures the address of the WWW site currently “in state” with the browser, creates and saves to disk an address directory record that includes the Web address in focus and inserts the WWW address mined into the WWW navigation address field of the invention client software.

Web browsers Microsoft Internet Explorer and Netscape Navigator both offer rudimentary WWW address mining capability, respectively “Favorite Places” and “Bookmarks.” Both utilities are woefully inadequate to aid a user with either addressing or knowledge of the addressed. Neither address directory survives a switch to another WWW access software; even upgrades within the respective brand may create conflicts and result in loss of files. Use of the WWW address mining feature in the invention business model and software captures the WWW address and creates a complete directory record in which a user may enter information pertinent and useful to the directory record; physical, WWW, and email addresses; voice telephone and fax numbers; executive, management and staff names; titles and areas of responsibility; business and personal alliances; and notes and conversation logs of previous transactions. The user interface thus offers on one screen the opportunity to conveniently record and recall a complete history of communications and transactions with the company or individual in focus. The Web site in focus can then be reached, directly, immediately in the future by “one click command” issued to the appropriate icon at the appropriate record in the invention client software.

When a Web site is reached using the invention software, the software identifies itself to the WWW server, enabling immediate access and availing the Licensed Venture Entity of relevant affiliate and transaction fees provided for in various fee arrangement contracts.

Address directory records stored in the invention software database may be associated by a record Link utility to establish and facilitate intuitive recall of stored data. When viewing a well-known first record, all records associated with the record in focus are displayed in the “Link” list box displayed on the address directory screen. While viewing the interface screen of a better known entity, a user can invoke, with one click, the Link listbox and thereby display a list of records associated with the better known person or entity. The feature is convenient and useful to rapidly locate and display directory information on an intuitively associated path to persons or businesses whose names are less known, or hard to remember.

Use of the client software to reach the Venture Server configured to deliver initial or subsequent editions of Bam!S information is more secure than a communication to a Web site made by use of conventional WWW navigation techniques because the WWW address at which new editions of Bam!S materials is written in the invention software database. This enables the Bam!S client software to reach the Venture Server address directly, with one click, and to automatically freshen edits of the BamS material in a direct communication over the Internet. As the distributee-user need not navigate manually through foreign WWW addresses to reach a desired WWW address, the user will avoid exposure to foreign SMD files in use by the most Web servers. Furthermore, unwelcome SMD files may be deleted from the distributee-user system using the invention software.

Overall security of a computer system and the personal privacy of a user is greatly increased by periodic examination and classification of SMD files. Deletion of unwelcome State Management Device files from a user computer, accomplished by the invention software, is an important weapon for use by consumers to protect their privacy. The subject examination, classification and deletion of SMD files is a preset run time function of the invention software.

State Management Device files, “cookies,” are employed by certain entities to record, profile and track Internet activity of a computer user. At launch of the SMD maintenance utility contained in the invention business model and software, the utility identifies SMD files in place in the distributee-user system and removes SMD files that do not contain pre-approved identification. The desire for privacy and the establishment of security offered by the SMD maintenance utility enhances, for every user, approval and comfort gained in use of the invention software. Reestablishment of privacy and security delivered in the invention software by the licensed distributor to every distributee-user is an important attribute of the business model and software product. The attribute is a powerful incentive to use the product and can be an important element of a lengthy and solid customer relationship.

The invention business model and software product enables and facilitates distribution and use of PKI (Public Key Infrastructure) encryption technology. Distribution of PKI elements to user systems is an expensive, thorny problem for every company and entity considering distribution of PKI to the WWW platform. Delivery of initial product and changes, enhancements and updates to PKI protocols may be cost effectively securely made to distributee-users of the invention software.

The invention software establishes a distribution vehicle that does not currently exist in the market. It need not have any affiliation to any software manufacturer or product, language restrictions, or operating system preference. Direct addressing, inherent in the invention business model and software product is used to secure transactions of every manner between a licensed distributor, distributor nominees, i.e. agents for the distributor, and distributee-users of the invention software.

The invention software also offers a utility that captures a document in current view in any Web browser. The feature is invoked by a “one click” command on the user interface of Bam!S software. When launched, the utility captures the entire document in focus, strips various formatting from the document and writes the captured document to the word processor set by preference, ready to be edited and manipulated by the word processor.

The invention software may be distributed initially either on floppy or compact disk or some other portable computer-readable medium, by various other physical methods or by delivery on the Internet. The software distributed is a licensed edition version of the client software that is specifically configured for the distributee-user, defined by demographic (i.e., specific profiles sketched by customer behavior and vital statistics, etc.) or geographic (i.e., defined by the area of customer influence) criteria. The Licensed Venture Entity operating the venture network is licensed to administer, develop, maintain and support the invention business model and software. The initial distribution of the invention software may contain Bam!S materials written to the business address directory file structure. Subsequent editions of Bam!S material may thereafter be delivered through either a continuous or periodic connection to the Internet. Using the Internet, customers may be permitted to update their user preferences to alter the database information and Bam!S messages they receive.

The business entity licensed to distribute the software, the Licensed Venture Entity, may deliver Bam!S materials to the established private network. Such delivery establishes a first source of revenue and value for the Licensed Venture Entity. The Licensed Venture Entity may contract with affiliates and entities related to the Joint venture, if any, to offer deliver Bam!S materials to the private network established for affiliates and related entities. Such fee arrangements establish a second source of revenue for the Licensed Venture Entity and their customers.

The Licensed Venture Entity may contract with third parties who wish to avail themselves of the opportunity to deliver Bam!S materials to the established private network. The third parties may choose from a complete menu of display and delivery options offered by the Licensed Venture Entity, from a simple display to a separate custom software product. Third parties may seek to join the Licensed Venture Entity at various levels of for-fee arrangements. Such fee arrangements establish a third source of revenue for the Licensed Venture Entity.

The Licensed Venture Entity may contract with businesses engaged in “e-commerce” efforts on the WWW to provide direct addressing services with which to route consumers, distributee-users, directly to an e-commerce site where the distributee-users may engage in a business transaction. Business advantages created by direct addressing services may result in affiliates fees generated by business transactions. Such affiliate fee arrangements establish a fourth source of revenue for the Licensed Venture Entity.

The Licensed Venture Entity may contract with businesses engaged in “e-commerce” efforts on the WWW to provide direct addressing services with which to route consumers, distributee-users, directly to an e-commerce site to engage in a business transaction. Business advantages created by direct addressing services may result in transactions fees generated by a business transaction. Such transaction fee arrangements establish a fifth source of revenue for the Licensed Venture.

An optional database array and user interface specifically designed for the hospitality industry may be configured in the invention software, either as a hospitality component or offered as a stand-alone software program. The invention hospitality software comprises an application database product containing one or more file records of establishments in the business of offering hospitality services to the market, such as hotels, foodservice, and tourist attractions. The database array and user interface contains multiple information fields, including fields for location, size, ratings, rankings (by ratings service and which may be evaluated by either industry profession or patrons of the establishments), a list of goods or services offered, and may offer photographs of establishments profiled and other pertinent directory and marketing information. Database records may be sorted and searched by various criteria; alphabetically by name of establishment; by geographic location of establishment; by rankings or ratings or types of services offered, etc.

Hospitality businesses may be required to pay for inclusion in the database directory. Various fee structures may be instituted, including, but not limited to, fees for Bam!S display and delivery. Affiliate and transaction fees may be instituted among all classes of affiliates who wish to avail themselves of the display and delivery opportunity. Display and delivery of enhanced Bam!S information may include expanded directory and marketing information such as a display of menus, property features, photographs, and market offerings delimited in specific time frames.

If an establishment has established an Internet presence, the Internet address may be written to the database record to permit a distributee-user to employ the invention software to direct any WWW access software to the indicated WWW address to gain knowledge of the establishment and to avail the distributee-user of goods and services offered by the business in focus. Upon contact with the WWW address of an establishment, the invention software will identify itself to the Venture Server to establish immediate recognition and permissions, and to establish qualification for affiliate and transaction fees payment on literal and virtual transactions completed as a result of the contact made.

The search and navigation facility included in the invention software enables a Licensed Venture Entity to levy affiliate marketing and transaction fees upon a business listed in the directory. Bam!S information is displayed during time the hospitality screen is in view on a distributee-user's computer.

As with the other components of the invention software, changes and future editions of the hospitality business component and Bam!S information of the invention software may be delivered to the distributee-user either in an Internet or telephone line connection to either the Venture Entity (or as part of a Joint Venture between two entities). Connection for updates is initiated either by preset automatic or manual command, in either transparent or user-aware transaction.

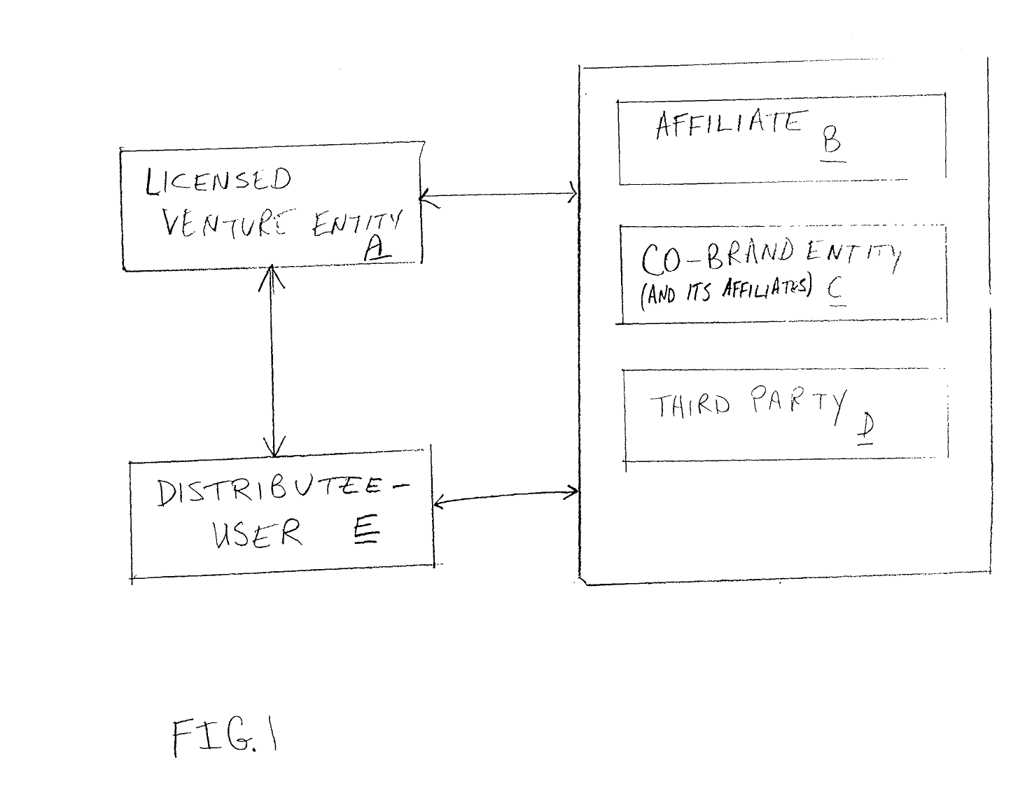

FIG. 1 illustrates participants and business relationships in a business model of the present invention. Licensed Venture Entity A obtains rights to distribute the invention software 33-37 (hereinafter, “software 33-37” may comprise just one of 33-37; e.g., 35) described below. Affiliate B may be a direct affiliate of Licensed Venture Entity A and has a pre-existing business relationship with A. For example, where Licensed Venture Entity A is an automobile manufacturer, Affiliate B may be a car dealership affiliated with Licensed Venture Entity A; where Licensed Venture Entity A is an insurance company, Affiliate B may be an agent for that company; where Affiliate B is a fast food chain, Affiliate B may be Licensed Venture Entity A's franchisee. Affiliate B will pay Licensed Venture Entity A for its participation or Licensed Venture Entity A may include Affiliate B as a benefit of the affiliation of Affiliate B with Licensed Venture Entity B. In lieu of or in addition to distributing the software 33-37 itself, Licensed Venture Entity A may arrange for Affiliate B to distribute the invention software 33-37.

Party C is a third party affiliate of Licensed Venture Entity A and may contract with Licensed Venture Entity A for distribution and display of Bam!S information, whether such data or information is disseminated at the time of the initial distribution of the Bam!S software 33-37 or at a later time. Party C may be referred to as a Co-Brand Entity and is an entity otherwise unaffiliated with Licensed Venture Entity A who wants to have its information and Bam!S messages included in the Bam!S software 33-37.

Party D may be third party advertiser who sponsors advertisments to be displayed on the invention software 33 but does not sponsor a full range of Bam!S messages. Distributee-user E of the invention software 33-37 are customers and prospective customers of Licensed Venture Entity A to whom the software 33-37 is distributed and may also be customers of B and C. Though distributee-users E may wish to avail themselves of BAM!S data distributed by Licensed Venture Entity A, they may have no desire to install multiple copies of various iterations of the invention software 33-37. Party C must therefore make an agreement with Licensed Venture Entity A if party C wishes to gain exposure to distributee-users E on the invention software 33-37 distributed. Party C contracts with Licensed Venture Entity A to add party C's Bam!S messages to the existing copy of the Bam!S software distributed by Licensed Venture Entity A. Parties C or D or a third party may distribute the invention software 33-37, either as a sole distributor or in cooperation with another one or more of the parties A-D.

Each version of the software 33-37 has a unique identifier and is distributed to a particular known individual. Third party advertisers can instruct that their advertisement only be sent to customers who meet certain criteria, such as residence in a certain geographic or membership of a certain demographic.

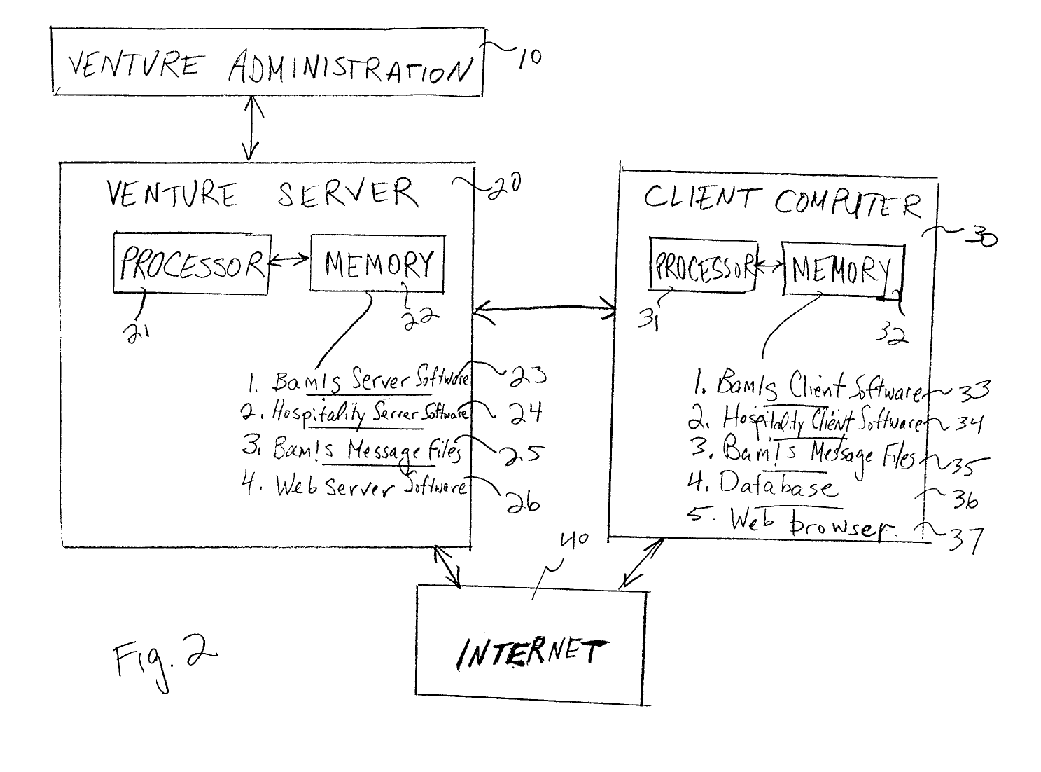

A Venture Administration 10 (FIG. 2) is established and administered by the Licensed Venture Entity A. Venture Administration 10 collects data and materials regarding customers and prospective customers of Licensed Venture Entity A and the Bam!S messages, and then stores the data. Venture Administration 10 may create and update software on the Venture Server 20 and client versions of the invention software 33-37.

A Venture Server 20 is a network server established by the Venture Administration to communicate via the Internet 40 with a client computer 30 operated by a distributee-user E, i.e. a customer or prospective customer. Venture Server 20 includes a processor 21 and a memory 22 in which the server Bam!S software 23 is stored. The Venture Server 20 also has stored in memory 22 master files containing the Bam!S messages 25, hospitality software 24, and software 26 for operation of a network Server. In addition, files (not shown) containing unique identifiers of each version of Bam!S client software 33-37 are loaded on the Venture Server 20 to enable the direct addressing of files containing Bam!S messages on a client computer 30.

Other than the specified software, Venture Server 20 may utilize conventional server hardware and software components known to those skilled in the art to communicate with a client computer 30. Client computer 30 similarly has a processor 31 and a memory 32. Resident in memory 32 is the client Bam!S software 33-37, client hospitality software 34, Bam!S message files 35, database 36 for Bam!S software 33-37, and conventional Web browser 37.

Revenue passes to A from all entities downstream of party A who contribute Advertising, Branding, Marketing and Service Messages to be displayed in the invention software and from various affiliate and transaction fees produced from distribution on the network. Licensing and services delivery fees will be paid by parties C and D to Licensed Venture Entity A. Parties C and D may also have to pay Licensed Venture Entity A either directly or indirectly for the Bam!S messages and a percentage or flat rate fees for goods or services sold, leased, or otherwise exchanged through the customer's use of the software. Parties C and D may bring affiliates (not shown on FIG. 1) who may be referred to as Subset Affiliates who, join with parties C and D in sponsoring Bam!S messages and otherwise using the software 33-37 as a network tool.

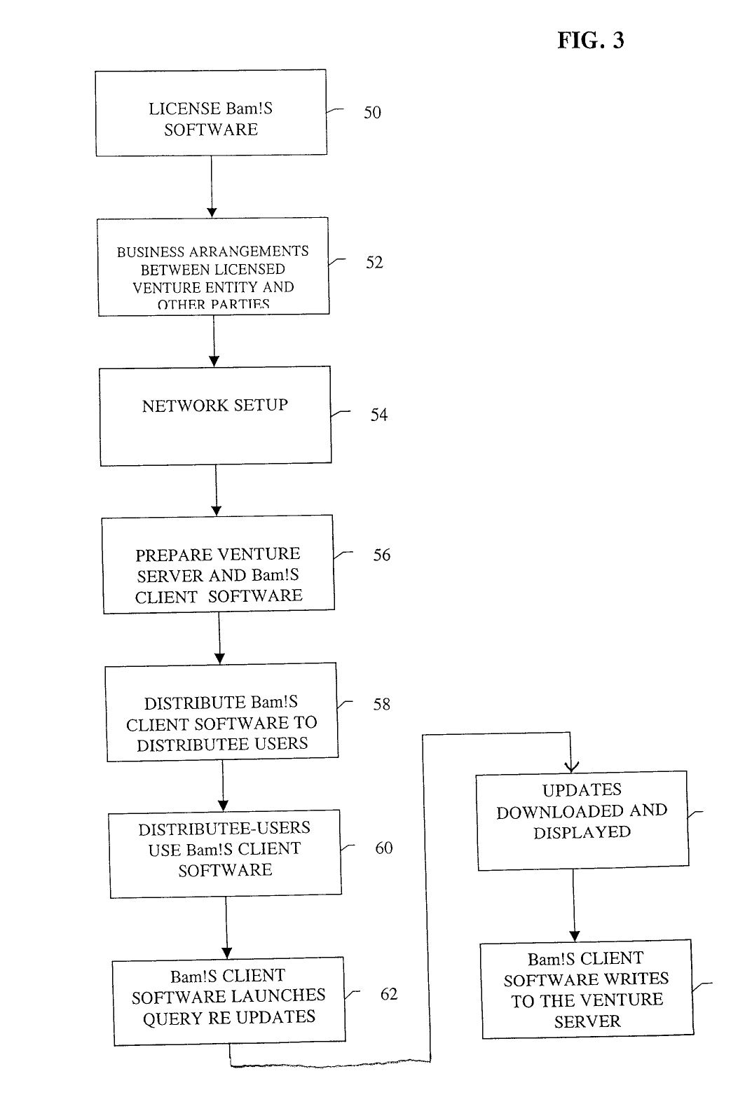

The flowchart of FIG. 3 illustrates the steps in practicing the business method of the present invention. At step 50, the Licensed Venture Entity A establishes and maintains the Venture Server 20. At step 52, the Licensed Venture Entity A optionally arranges with others to affiliate with it by one of various means of affiliation to incorporate Bam!S messages in the invention software 33-37. At step 54, the network, including the Venture Server 20, is set up to communicate with the client computers 30.

The application-specific software 23 for Venture Server 20 and the client application Bam!S software 33-37 for client computer 30 are prepared, at step 56. The server software 23 is prepared according to the needs of the Licensed Venture Entity A, party C, participating affiliates B, and affiliates of party C, and thereupon loaded onto the Venture Server 20.

The Bam!S client software 33-37 is configured as a specific version for each user, each version being assigned a unique identifier to enable the direct addressing of files by the Venture Server 20 addressed to each client version. The Bam!S server software 23, customized according to the needs of the Licensed Venture Entity A, utilizes conventional Internet application software present to communicate with the Bam!S client software 33-37 over the Internet 40.

At step 58, a customer-specific version of the client software 33-37 is distributed to user for use on one or more computers 30—whether mobile or stationary—to enable and establish the private network for communication to be exchanged between the Venture Server 20 and the client computer 30. Licensed Venture Entity A may distribute the Bam!S client software 33-37 for free to its customers. Licensed Venture Entity A has information about its customers from previous business contacts with them and uses that previously-compiled information to prepare and distribute the version of the software 33-37 that is customized to the user to include customized preloaded database information and Bam!S messages targeted to the user.

At step 60, the client software 33-37 is installed by the customer or “user” on the hard drive of the customer's personal computer. The client software 33-37 may be started by clicking on an icon on the display that is a logo for the Licensed Venture Entity A. The user is exposed to the Bam!S messages while the Bam!S client software 33-37 is in use.

Updates to the client software 33-37 and Bam!S messages files 35 are made by launch of a query from the Bam!S client software 33-37 to a user-specific Web address (step 62) to seek new or updated information stored in files resident on the Venture Server 20 that are addressed to the particular customer-specific version of the software 33-37. The query is launched either automatically by the client software 33-37 in a transaction that is transparent to the user or by a command issued by the user E of the client software 33-37.

In response to the query, files (including Bam!S message files 35 and any updates to client software 33-37) resident on the Venture Server 20, are sorted and addressed either by demographic or geographic criteria, or specifically addressed by off-system criteria are delivered to the unique address of each version of the client software 33-37, written to the client software 33-37 and displayed on the user's screen (step 64). The specifics of where the files are loaded and when to terminate the connection between client computer 30 and Venture Server 20 is specified by an instruction either from the client computer 30 or from the Venture Server 20. Either in response to information delivered by the Venture Server 20 to the client software 33-37 or in initiation of a new communication, the client software 33-37 writes to the Venture Server 20 information required to either initiate or continue a dialog (step 66).

The business method of the present invention is appropriately applied to numerous different lines of business. For example, in the banking business, a financial services provider may be a stakeholder in the Licensed Venture Entity A and may use the software to promote the financial services offered, to improve customer relationships and retention, to provide an electronic wallet utility, and to deliver authentication keys, i.e., public keys for PKI encryption, for electronic banking transactions. The Licensed Venture Entity A can contract with Affiliates B of the stakeholder and third-party advertisers D to incorporate Bam!S messages from the affiliates and advertisers into the Bam!S client software 33-37. Affiliates B may be either first magnitude businesses i.e., a businesses with a global or national presence, or local unit consumer businesses who can use the software for the same purposes as the Licensed Venture Entity A and who cooperate with the Licensed Venture Entity A to market the brand, to provide customers with a demographically targeted local area directory, and to disseminate product information. The Affiliate B will pay the Venture fees including branding, advertising, marketing and service delivery fees; and affiliate marketing and transaction fees.

Another application of this business model is as a model for a print publisher who publishes publications like magazines and directories for the travel market. This Bam!S software 33-37 helps advertise the publisher's products, market the brand, acquire and retain subscribers, and deliver authentication keys. The publisher will pay the Licensed Venture Entity A for its services and licensing fees and can earn revenue from its contracts with affiliates that require payment of marketing and transactions fees and from contracts with third-party advertisers for timed displays of advertising. Affiliates of the publisher who may wish to join the publisher in using this Bam!S software 33-37 for promotional purposes include a single unit or multi-unit hotel and lodging operator, a travel agent, and a travel-related business merchant. Using the Bam!S software 33-37, these affiliates can jointly market the brand, deliver product and service information, deliver authentication keys, and sell timed display advertising. The affiliates pay the Licensed Venture Entity A advertising and branding fees and affiliate marketing and transaction fees. This business model is also applicable to a credit card corporate parent like Master Card® who, as a stakeholder in the Licensed Venture Entity A, uses the software to market its brand, generate customer loyalty, and deliver authentication keys. Fees to the Joint Venture Entity A include a timed display contract fee, and accreted value. Affiliates of the credit card corporate parent are issuers, like a bank, processors, and merchant accounts. The banks and area merchants benefit by marketing and advertising the brand, providing customers with a directory of local banks or merchants, and delivering authentication keys. Affiliates pay fees to the Licensed Venture Entity A for marketing and advertising, and possibly fees based on transactions generated through the use of the software 33-37. Banking businesses may also use the software 33-37 to deliver monthly bank statements and other communications to their customers.

A fourth line of business in which this business method is useful is in the airlines business. Engaged as a stakeholder in a Licensed Venture Entity A, an airline can use the software 33-37 to enable fast access to a Web site, deliver marketing materials, notices, and authentication keys, and generally market its brand. Affiliates of the airlines include Web-based sales agents, whether subsidiaries of the airline or a third party travel agent, can use the software in similar circumstances. Fees from the affiliates to the Licensed Venture Entity A include marketing and transaction fees, advertising and branding fees, ticket and itinerary delivery fees, and timed display advertising contract fees.

The above applications of the invention are presented only as examples. There are many other possible ways in which a business may utilize Bam!S software 33-37 to communicate with its customers.

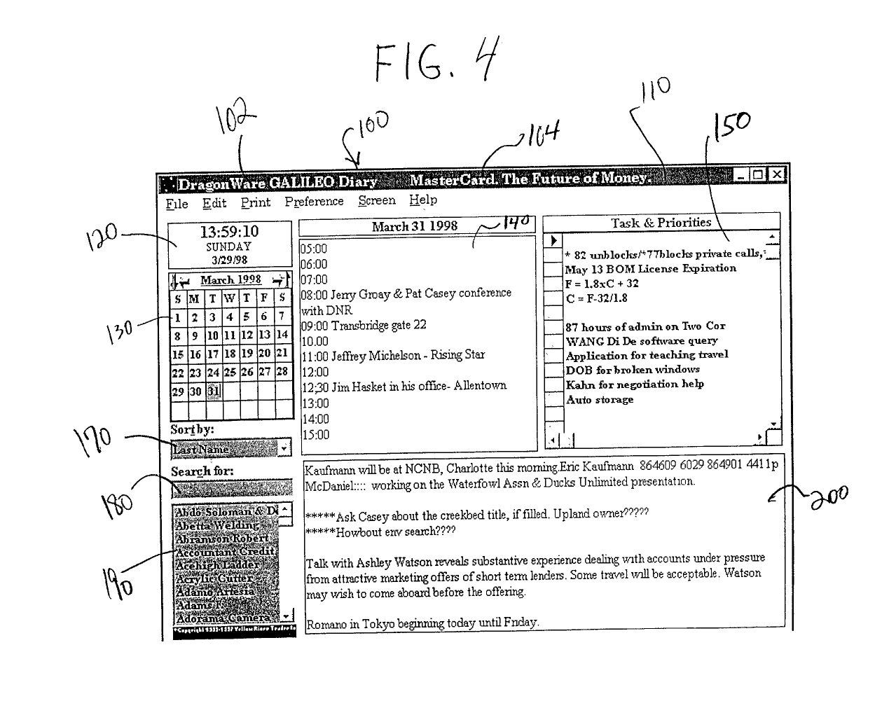

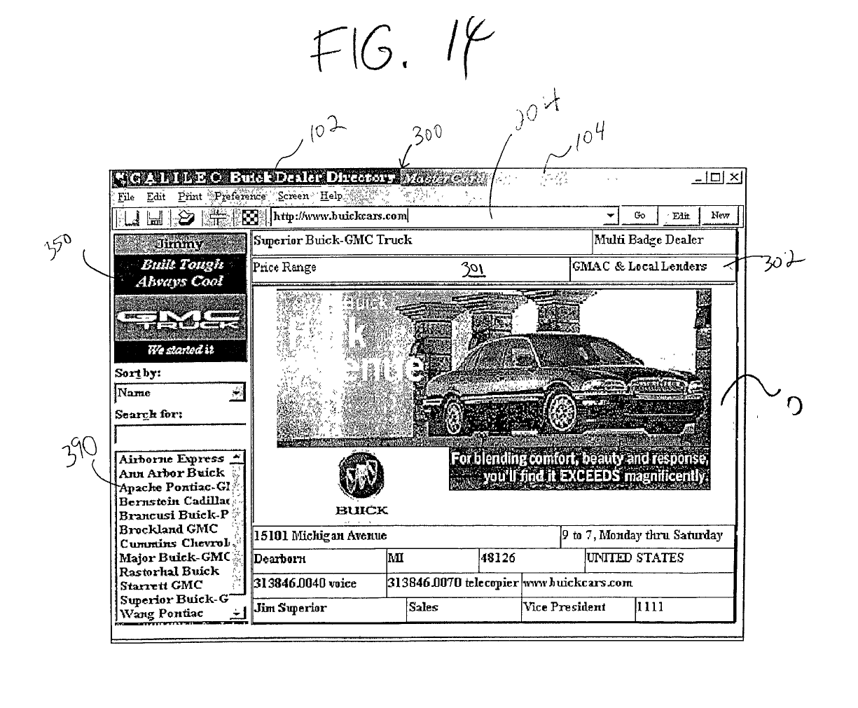

The Venture client software 33-37 comprises a suite of productivity utilities, including an address directory, a diary, and a financial journal. In addition to the core productivity utilities, the Bam!S client software 33-37 contains numerous enhancements that are described with reference to FIGS. 4-14, which illustrate sample screens. The enhancements include the distribution of a database 36 personalized by the Licensed Venture Entity A to each customer and linked to the Bam!S messages. The software 33-37 is a multifile database product that allow more than one user of the computer to record an individual profile.

FIG. 4 shows an example of a diary screen 100, which may be the first screen that can be viewed upon startup of the program. In the illustrated screen, all of the diary fields are contained on a single screen. At the top of screen 100 is a Title Bar 110. Towards the top left of the screen is a field 120 displaying the time, day, and date. Beneath field 120 is a calendar field 130 and to the right of the calendar field is an appointment schedule field 140. In the calendar field 130, the user can change the month viewed and can also select a particular date whose schedule will appear in field 140. To the right of field 140 is a “Tasks and Priorities” field 150, where one may make various entries. The view in field 150 is not date specific so it will not change as the date for field 130 changes. Field 200 is a “Notes” field where one may make various entries and export the entries to an Address Directory screen. Fields 170-190 relate to the address directory interface. Field 190 lists the names of persons or entities in the address directory. Sort listbox 170 offers a pull-down menu to select the sort category of names in address directory field 190 and what field in the address directory is to be searched. Search field 180 allows a user to enter a name to be searched in the address directory.

One suitable place for displaying Bam!S messages on the diary screen is on the Title Bar 110 which contains two fields 102, 104 customizable by the Licensed Venture Entity A to include any Bam!S message, but primarily suited to carrying branding and marketing information. In the screen shown in FIG. 4, field 102 simply has a possible name for the program “DragonWare GALILEO Diary.” Field 104 contains a message for “MasterCard,®” who may be a stakeholder in the Licensed Venture Entity A, and a slogan for MasterCard® “The Future of Money”. (FIGS. 4-14 contain registered trademarks of third parties and is used for illustrative purposes only.)

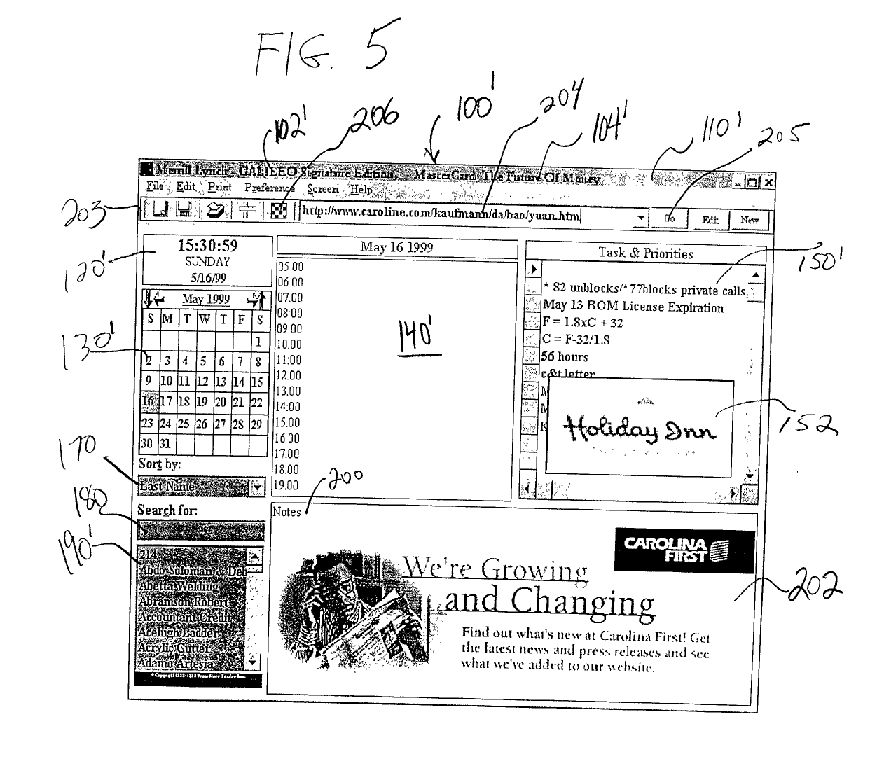

FIG. 5 illustrates how the diary screen 100′ might look where the software is distributed with Merrill Lynch® as the Licensed Venture Entity A. The illustrated screen 100′ has fields 110′, 120′, 130′, 140′, 150′, 190′ corresponding to respective fields 110, 120, 130, 140, 150, 190. The Merrill Lynch® name appears in field 102′ on the Title Bar. MasterCard® may contract with Merrill Lynch® to advertise in field 104′ as a Co- Brand Entity C. A logo (not shown) could be displayed in field 102′ as well). The field 104′ for the Co- Brand Entity C may have a timed display for alternating the messages of the Co- Brand Entity C that are displayed. In addition to the Bam!S messages on the Title Bar 110′, additional Bam!S messages may appear on other portions of the diary screen 100′, such as a timed display in Notes field 200. For example, the Carolina First® Bank may wish to advertise its services and contracts with Merrill Lynch® on this program. The Carolina First® advertisement 202 may then appear in the Notes field 200 when the Notes field 200 is not used after a certain timeout. Similarly, Holiday Inn® may contract with Merrill Lynch® to advertise one or more of its brands on the software and an ad for Holiday Inn® 152 may be written, as shown, above a portion of the Tasks and Priorities field 150′.

The advertising placed by MasterCard®, Carolina First®, and Holiday Inn® may be placed for a limited period of time, such as for 90 days, and may run in various rotations on various screens. The messages can also move around the screen or remain where they are first displayed. A message may also alternate with a message from one or more other advertisers.

The customer's computer 30 on which the Bam!S client software 33-37 is loaded may have a constant Internet connection or an intermittent Internet connection. The Bam!S information and message files 35 and all or some of the software 33-37 may be updated on the Internet 40 during an Internet session. If there is only an intermittent connection, the computer 30 may either automatically connect or may await the user's dialing into the Internet 40. The Internet address necessary for an update of the software is written to the software 33-37.

The Web address for each record in the address directory may be entered in the Web address field 204 in Tool Bar 203. To go to the displayed Web address, a user must click on the “Go” button 205. This launches the designated Web browser 37 and starts an Internet connection to that Web site to be viewed within the Web browser 37.

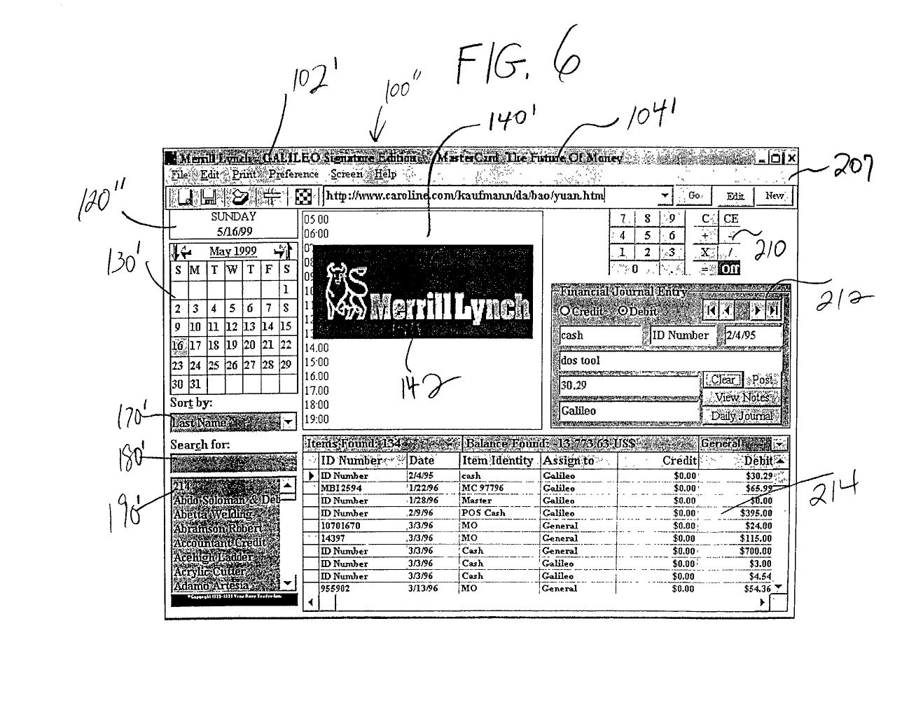

FIG. 6 illustrates a “Financial Journal” screen 100″, which may be included in some or all versions of the software. This screen, which is particularly useful for a financial services company like Merrill Lynch® to distribute, is similar to the diary screens 100 and 100′ except that the Tasks and Priorities field 150, 150′ and the Notes field 200 have been replaced with other finance-specific fields, including a calculator 210, a Financial Journal Entry area 212 having multiple information fields, and a Financial Journal 214 (entries to which are added at 212). A Merrill Lynch® logo 142 is written above the appointment schedule field 140′. The particulars of how the Financial Journal 214 works are unimportant for the purposes of this application. However, it illustrates how the software 33-37 may be customized for interests of various possible Licensed Venture Entities.

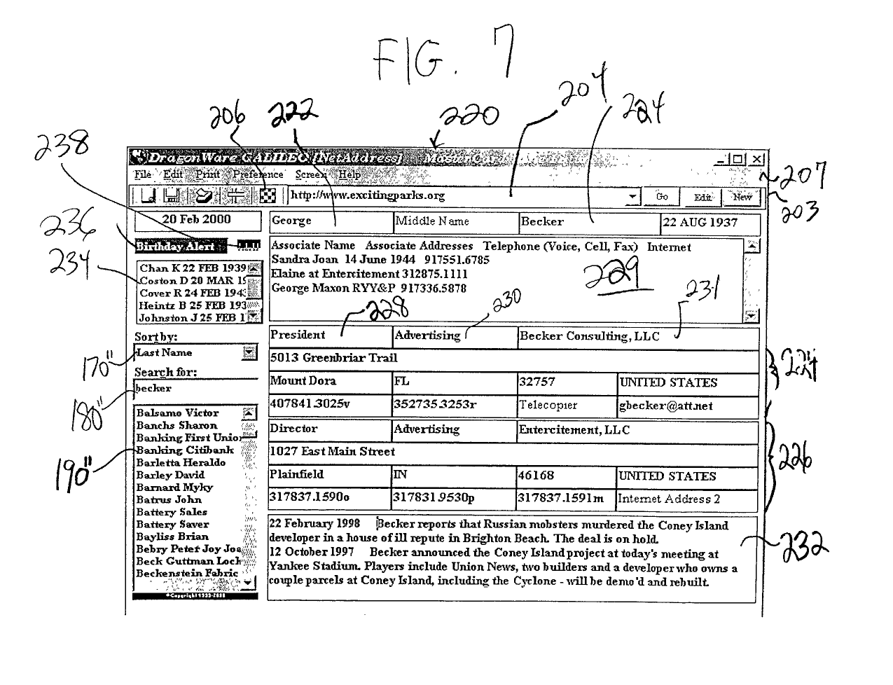

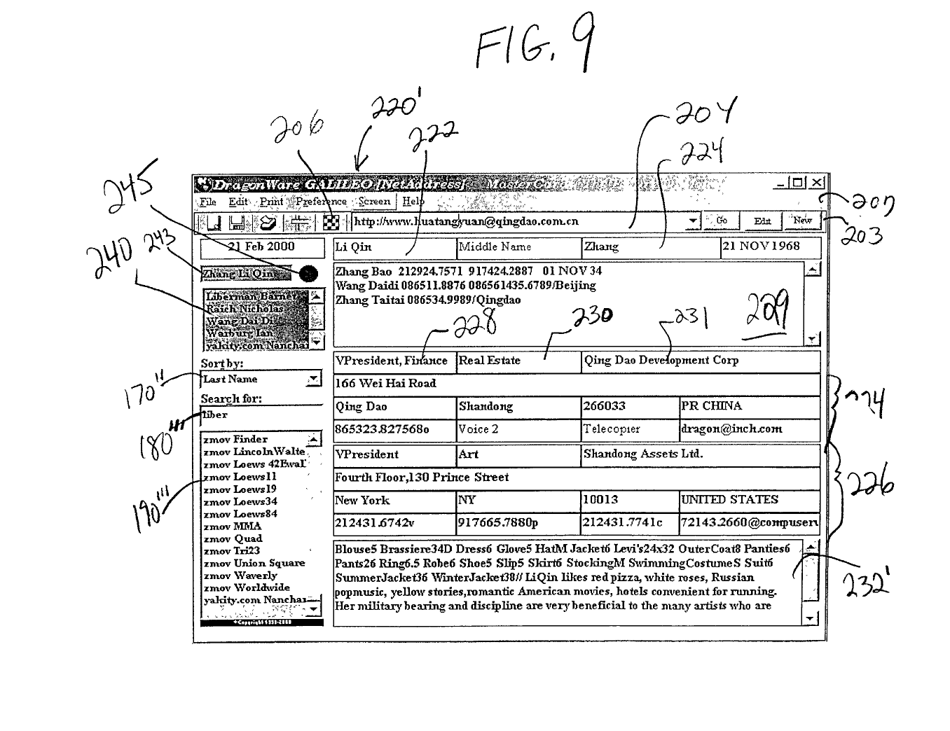

A sample address directory screen 220 where all of the address directory fields are displayed on a single screen is shown at FIG. 7. One may switch between the diary screen 100, Financial Journal screen 100″ and the address directory screen 220 by selecting from the Screen pull down menu on the Menu Bar 207. The address directory screen 220 displays Sort, Search and address directory record list fields 170″, 180″, 190″. In addition, the address directory screen includes a list field 234, such as a list of upcoming birthdays or anniversaries, and numerous information fields on the right side of the screen. Among the information fields, there may be fields for first and last names 222, 224, job title 228, notes 229, type of business 230, employer 231 and various other fields for employer information 224, as well as similar fields for information about a second employer 226. There may also be a second notes field 232 where personal data about the person or entity may be recorded. This second notes field 232 may be a general notes field like notes field 229. In one example, field 232 lists clothing sizes and preferences (FIG. 9). The notes included in fields 229 and 232 may be exported from the notes field 200 of diary screen 100. The illustrated example of FIG. 7 shows record information for someone named “George Becker” whose record was searched for in field 180″ and shows records in the record list field 190″. Address directory records may be entered by the either the Licensed Venture Entity A or a user.

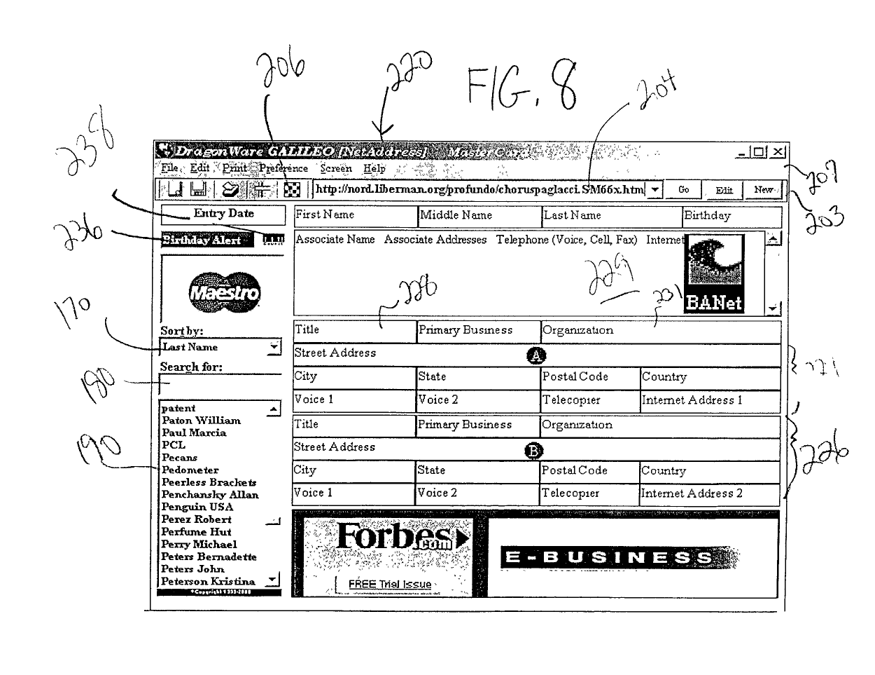

FIG. 8 shows an address directory screen 220 without any record selected. The information fields show descriptors of their purpose to prompt the user to enter the appropriate information in the various fields. Messages for Maestro, Forbes.com, E-Business, and BANet are written to various areas of the screen after a timeout when no records have been accessed.

A user may link records in the address directory by entering in list 240 a name of a record other than the record being edited. Upon command, a link list field 240 (FIG. 9) opens in place of list 234. There may be multiple links. For example, as shown in FIG. 9, the selected record in address directory list field 190″′, Li Qin Zhang, is associated with Barnet Liberman, Nicholas Raich, Dai Di Wang, Ian Warburg, and Nanchang yakity.com. This linking feature is helpful to track various relationships between persons or entities in the address directory list 190 and helps a user find a desired contact when the user can only remember the name of another person or entity linked in some way to the desired contact, such as a business partner or acquaintance. Once the New Record is entered, this link list 240 opens by clicking upon a name in the address directory list field 190. The links may be sorted and searched by last name or by any other information fields of address directory screen 220′. To use the link feature when a record is opened, the name selected in the address directory list field appears in field 243 and any previously entered links appear in field 240. One may then click on a link in field 240, if there is any, to call up that linked record's information to appear on the screen. Clicking on icon 245 allows the entry of additional links.

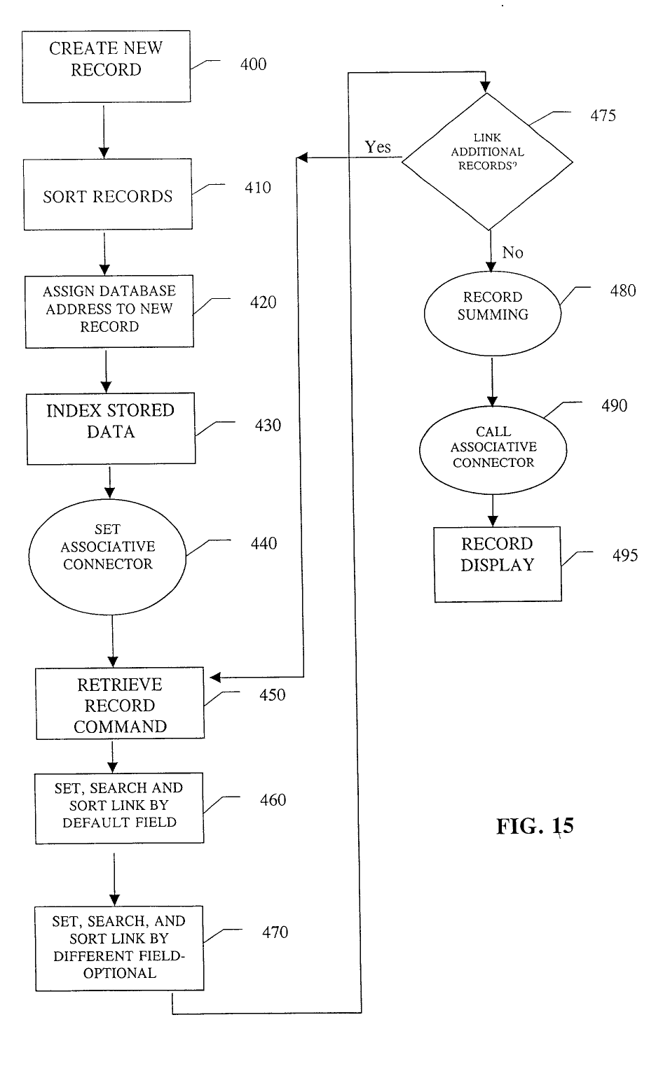

FIG. 15 shows the flow chart for the algorithm for linking records in the database with links 240. The algorithm begins when at least one record, such as a record for Barnet Liberman, is already entered in the database and a second or later record is to be entered. At step 400, the New Record command is selected, permitting data entry into the information fields for a new record, such as the record for Li Qin Zhang shown in FIG. 9, by manually inputting information to the information fields on the address directory screen 220′. After the information for the new record is entered, the new record for Mr. Zhang is sorted (step 410), assigned an address (step 420), and indexed (step 430) in the database by the computer 30. At step 440, the link field box 240 opens to permit the entry of one or more links (also known as “associative connectors”) to existing records. To select an existing record to be linked with the new record, such as the record for Mr. Zhang in FIG. 9, a search is performed to retrieve the existing record (step 450) by entering the information to search for in the information field specified in field 170″ into field 180″′, such as entering the name Liberman into field 180″′. when field 170″ is set to Last Name. The user need not necessarily enter the entire name Liberman, but may enter several of the first letters, such as “Liber” if those letters are sufficient to distinguish between records. The links are by default sorted and searched by last name, such as Liberman, to appear in the link field box 240 (step 460).

If one wishes to set a link by linking a field other than by last name displayed in the link field box 240, at step 470, one selects an alternative field to be displayed by selecting the desired field from the menu in Sort field 170″. At step 475, it is determined whether there are additional links to be entered. If there are, steps 450-475 are repeated until the additional links are entered. When there are no further links to enter at step 475, at step 480, the user clicks on icon 245 to close the link field box 240. The linked records are then summed i.e., tagged for association. Once the links are saved, one may click on a record in the address directory list field 190 (step 490). This causes the information for the entire record to be shown in the information fields on address directory screen 220′, including the links in the link field box 240, which pops open (step 495).

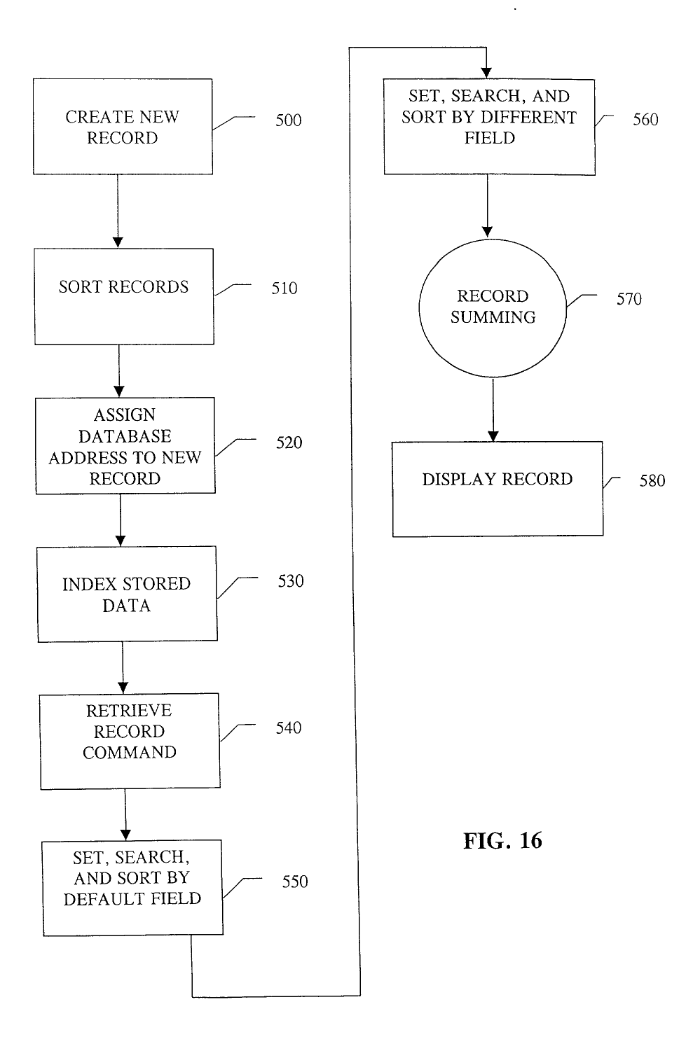

As the linking algorithm of FIG. 16 makes clear, in searching the records within the database 36, it is possible to search the records not only by last name but also by searching any specified information field or all of the information fields jointly. The selected option may be chosen from a pull-down menu from the search field 170″ (FIG. 9). Thus, as shown in the flow chart of FIG. 16, after records are created (step 500), sorted (step 510), assigned addresses within the database 36 (step 520), and indexed (step 530), a record can be retrieved (step 540) by searching the record by the last name field (step 550), which is selected by default in field 170″ or by selecting an alternative information field or selected an “all fields” selection from the pull-down menu of field 170″ (step 560). Once the field to be search is selected, the records are searched (step 570) and the selected record is displayed (step 580).

Additional functionality is added to the address directory screen by a WWW Address Mining and Navigation (AMN) function. While using prior art Web browser software 37, Web site addresses “Bookmarks” and “Favorites” (a.k.a. Uniform Resource Locators or “URLs”) may be recorded or saved. However, the Bookmarks and Favorites lists are not readily transportable between applications and may not survive upgrades to the application. Additionally, information about the address (a Web site, for example) such as the business sponsorship and other pertinent information cannot be stored. The AMN function enables capture of the Internet address while one is simultaneously connected to the Internet with a browser 37 opened in a separate window, by clicking on the harlequin pattern icon 206. Enriching contextual information may be simultaneously or subsequently recorded in the address directory. Future visits to the recorded Internet address may then be initiated by single click on the “Go” button 205. Internet address recordation, navigation and storage is enabled, enhanced and simplified.

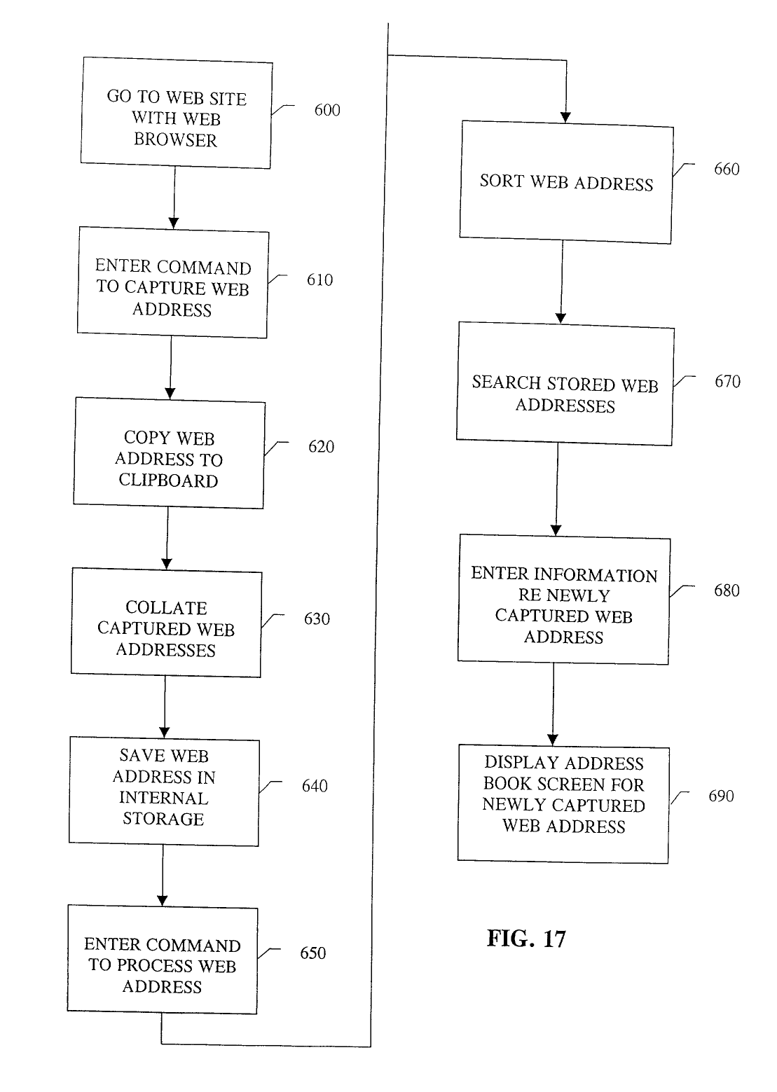

The flow chart for the AMN function is shown in FIG. 17. At step 600, the user visits a Web site using a designated Web browser 37 to display the desired WWW document. Next, the user issues a command to either the Venture Client interface or to a Venture Client icon 206 resident in the Windows Task Bar 203. The Venture Client command captures the Internet address in focus in the Web browser software 37 (step 610), copies the address to the clipboard and then sends, writes and saves (steps 620, 630, 640, respectively) the address to the Venture Client database 36.

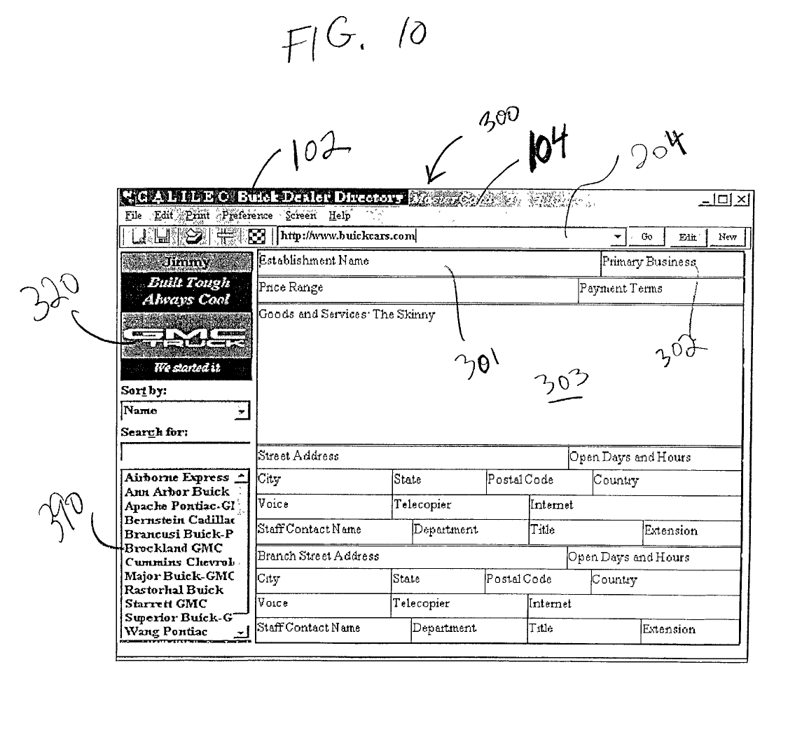

The address now appears in the Internet address field 204 of the tool bar 203 and is associated with blank fields as in screen 300 of FIG. 10. At step 650, the user may enter information into the various address directory fields. Contextual information can be written to participating Internet address files. Upon execution of the Mining action described, the data is captured, sorted (steps 660, 670) and written to the entered fields according to a predefined process (step 680). The Venture Client product then displays Internet address and related information entered into the various fields at step 690.

The AMN functionality adds another economic opportunity for revenue to the Licensed Venture Entity A because the Licensed Venture Entity A can enter Internet addresses and related information for selected Web sites into the Bam!S software, including an Internet address and related information for participating sites, to create an Internet directory.

In an application of the business method by car manufacturers, a customized address directory screen 300 is prepared and is shown in FIG. 10. In FIG. 10, the Buick® car subsidiary of General Motors® or General Motors® itself is a stakeholder in Licensed Venture Entity A. When the Buick® screen is selected, the personal address directory interface 220 is written with screen 300. The names of the participating dealerships who have contracted with the Licensed Venture Entity A as Affiliates B appear in field 390. As with the personal address directory, a record could be selected and the information for that record is then shown on the right side of the screen. The records may be sorted and searched by a single field or by more than one field, including by all fields. The field 102 prominently displays that this screen is the Buick® Dealer Directory. Buick® may also contract with a Co- Brand Entity C like MasterCard® to post the MasterCard® name and slogan in field 104. Instead of the clock and calendar fields 120, 130 in the screen of FIG. 5, an ad for a GMC truck 320 may be displayed.

The screen 300 shown in FIG. 10 is a sample “dealer information” screen wherein the information fields show descriptors of their purpose, like the dealership name 301, its primary business 302, types of Goods and Services offered 303, etc. The number of information fields and the field types may vary. When a dealership record is selected, these fields show the indicated type of information. The Buick® Web page address is provided in field 204 when no dealer name with its own Web address is selected.

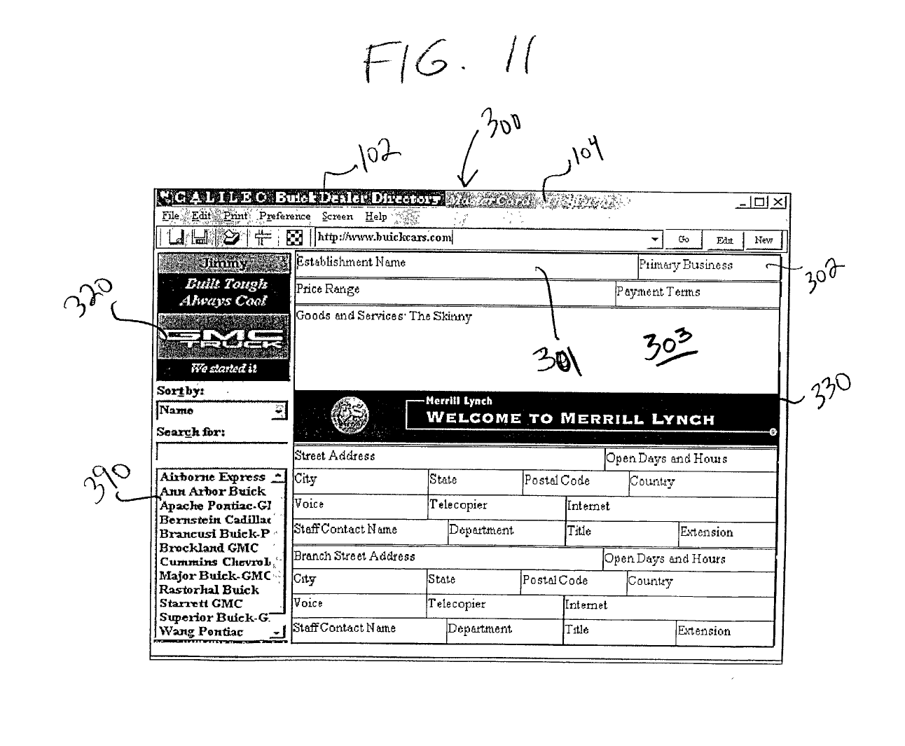

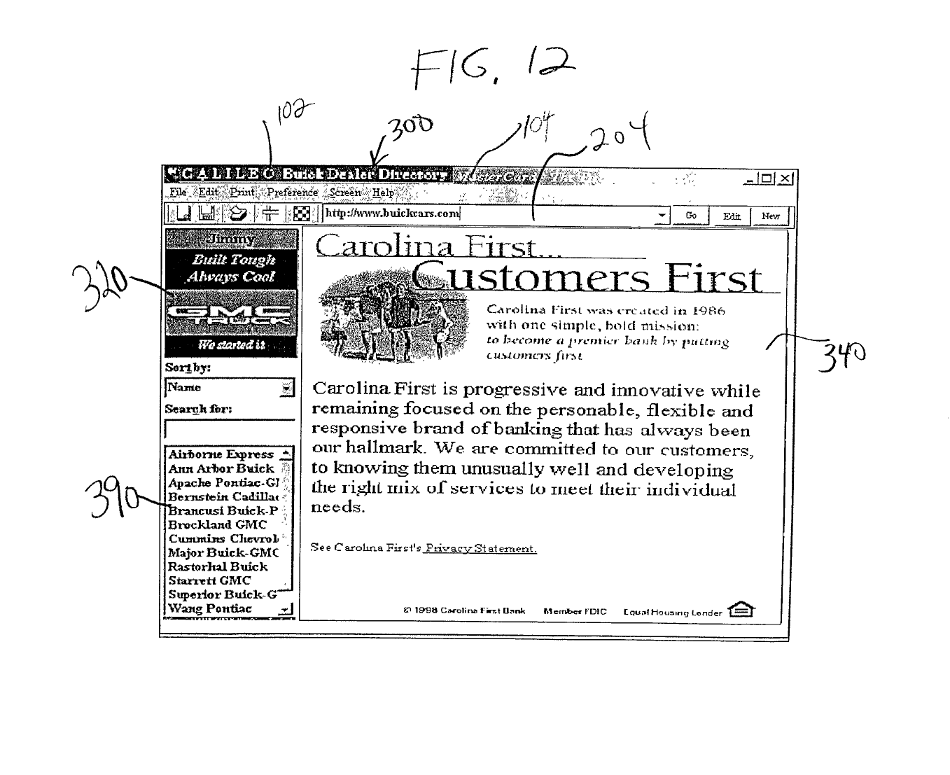

A different Co- Brand Entity C, such as Merrill Lynch®, may contract with Buick® to present a message or logo 330 on this screen, such as in the Goods and Services field 303. (FIG. 11) When not in use for a period of time, the address directory fields is written with an advertisement, such as an advertisement for Carolina First® Bank, which covers the Notes field and several other information fields shown in FIG. 10. (FIG. 12).

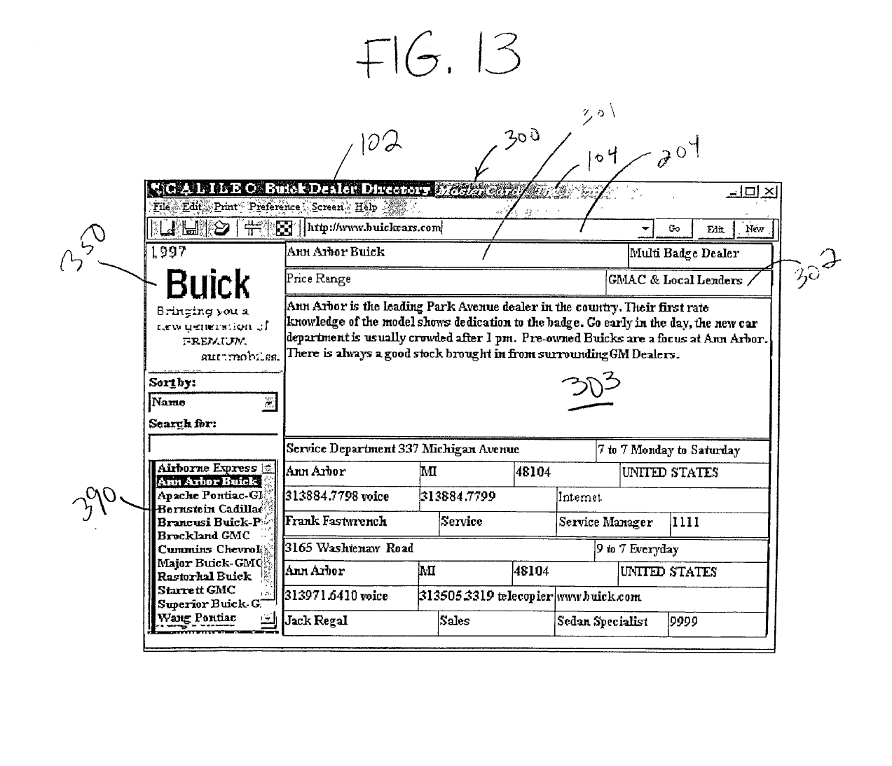

By selecting the “Ann Arbor Buick” record in the dealership address directory 390, one causes data for that dealership to be displayed in the information fields (FIG. 13) and an ad for Buick® 350 may then replace the ad for the GMC truck.

As one of the fields on the address directory screen, there may be a graphic 360, which can be used to illustrate a Buick® product and show other graphical and textual Buick® Bam!S messages. The graphic 360 may be set to appear when the dealership screen 300 is displayed but the Bam!S client software 33-37 remains open and in focus but is not accessed for a certain period of time. The illustrated graphic 360 may alternate after a certain period of time, such as 10 seconds, with a price quote request, service bulletins, or a range of forms to deliver or request customer information. A multimedia application may be bundled into the client software 33-37 for playing multimedia Bam!S messages, should such messages be supplied.

In addition to the features mentioned above, the distributed client software 33-37 may also be provided with various unique features that further enhance its value, including security features. One significant security feature is PKI encryption which is a well-known, extremely secure encryption algorithm used for conducting e-commerce between e-commerce companies and their customers, between credit card issuers and card-accepting merchants, and between financial services enterprises and individual users of cards. This algorithm is far more secure than the Secure Socket Layer (SSL) used today by many Web sites.

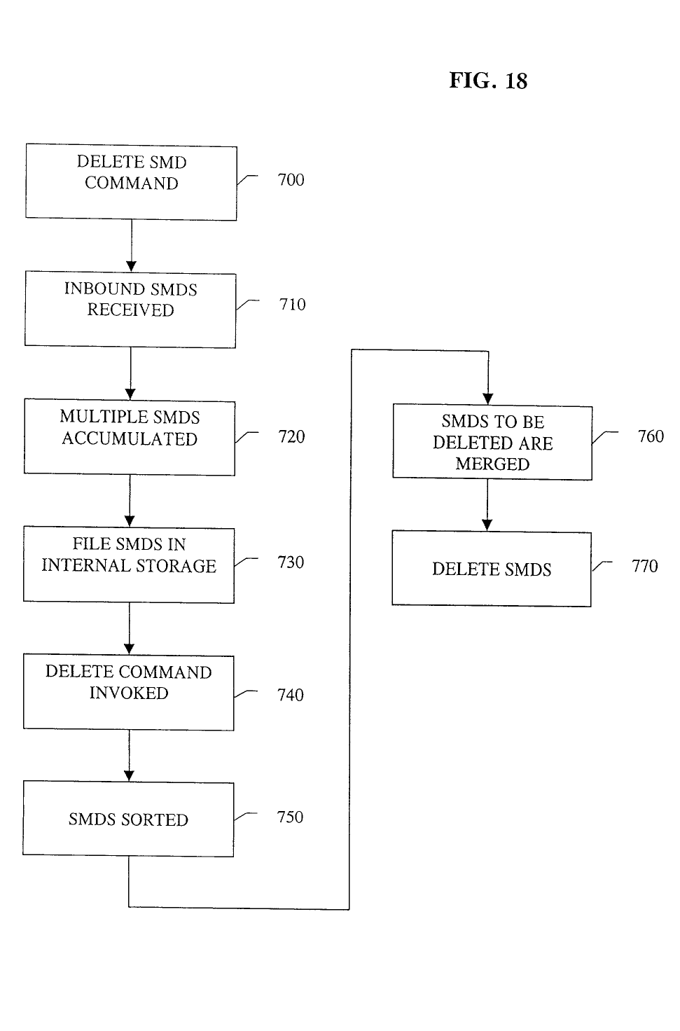

To further enhance security, a unique cookie management feature may be added. This feature does not block cookies since the cookies are needed during sessions to maintain the session and because entry to certain Web sites require the cookies to be accepted. Instead, the algorithm described in the flow chart of FIG. 18 is provided as an option to the user of software 33-37 and selectively deletes unwanted cookies.

At step 700, the user selects whether to utilize the Delete Cookies option. This step may be invoked at any stage, which may be during or after a Web session, or at any other time and, if the deletion option is selected, it will cause the algorithm to run at some point, such as on-the-fly, after a Web session has ended, at logoff or shut down, at start up or at other regular intervals. At step 710, a cookie (or State Management Device (“SMD”) arrives at the user's computer, the cookie is associated with a file in which cookies for multiple documents (i.e., pages on Web sites) are accumulated (step 720), and the cookies are stored in internal storage on client computer 30 (step 730). If the Delete Cookies option is selected, the program issues the Delete Cookies system to the operating system (step 740). The SMD Sort command is issued at step 750 and commands determination of which cookies should be deleted. To execute this step, the user may in advance specify what not to delete either by specifying the type of file or specific file names not to be deleted in software 33-37. The delete decision is facilitated by examining the identification of the cookie. After the cookies are sorted, the cookies that should be deleted are merged at step 760 and extracted (deleted) at step 770.

As an additional security measure, the software 33-37 may also be password protected to require a password in order to access the Web address of the Licensed Venture Entity or an affiliate.

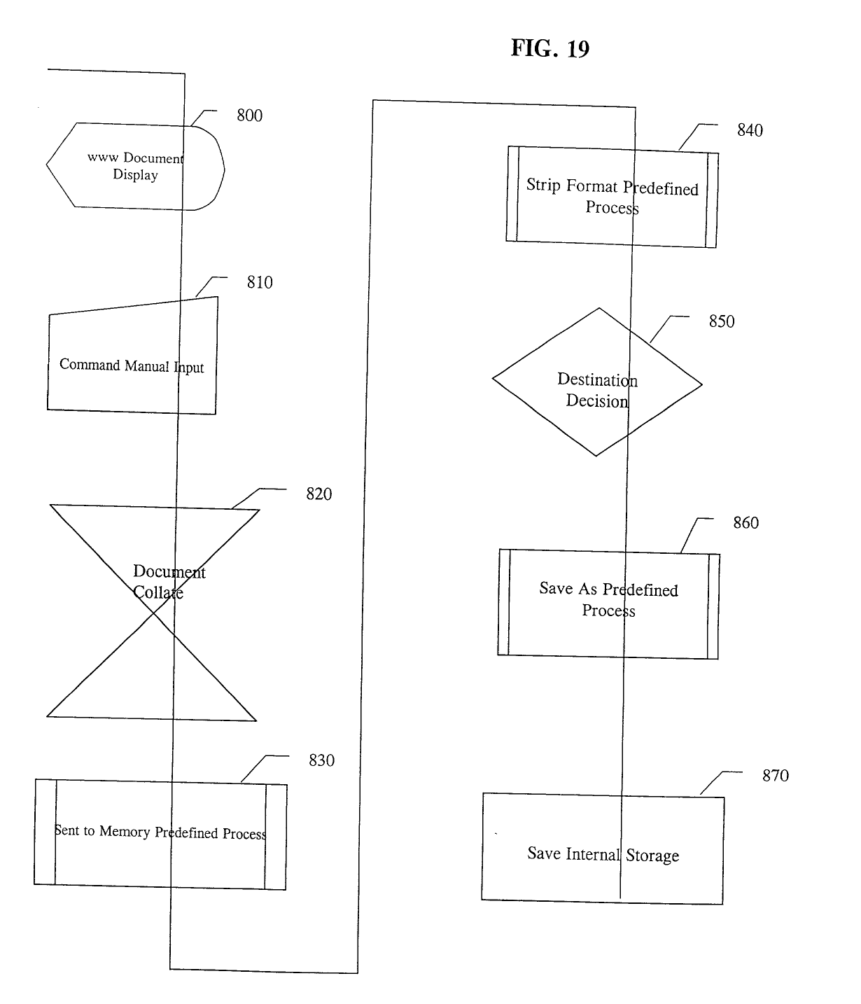

Another feature geared to enhancing the functionality of the software product 33 and which is expected to draw users to the product is a feature that may be called “WWW Document Mining and Storage” algorithm (“DMS”). This feature is designed to strip downloaded documents of formatting instructions used within the documents posted on the Web. Web documents are posted in a host of formats, including some non-proprietary formats like HTML (Hypertext Markup Language), and XML (Extensible Markup Language), and some proprietary formats like PDF. Arcane procedures are often used in the prior art to prepare documents for local storage and to manipulate text for subsequent editing, recall and display. Designed to eliminate these deficiencies, the DMS algorithm of FIG. 19 can be programmed to work with any Web browser 37 to strip various types of formatting so that the Web document in focus can be saved as a text document.

The DMS algorithm starts at step 800 when, from within the Web browser 37, a user goes to a document posted on the Web. The user then enters a command that captures the document shown on the Web browser 37 (step 810). This command is preferably entered at the Bam!S client software 33-37, as with an icon (not shown) because this brings the user to the Bam!S client software 33-37 yet again. Upon receiving the command at step 810, the client computer 30 copies the text of the entire document to the system clipboard, where the document is collated (step 820) by putting together pieces of the document, such as pieces of the document initially in different fonts. The document is sent to the computer memory 32 (step 830) and the formatting is stripped at step 840. The document is then sent to its previously selected destination, such as to a word processor like Microsoft® Word or Corel® WordPerfect, as an unformatted text document (step 850). The unformatted document is saved as a formatted document at step 860 and is saved to internal storage (memory 32) at step 870. The process terminates at step 880.

In accordance with the business method of the present invention (as shown in FIG. 3 but substituting the hospitality client software 34 for the Bam!S client software 33-37 shown therein), a hospitality client software 34 component may be added to the existing software 34 and may appear to the user as a separate screen or may be distributed in lieu of the Bam!S client software 33-37 as a separate but related program that is opened with a separate command or icon.

The hospitality software component enables users to learn about various places to visit and establishments in those places, including hotels, restaurants, and tourist attractions for various cities, and rates and ranks the establishments. A Licensed Venture Entity Affiliate B may reach an agreement with Licensed Venture Entity A to further develop and maintain the hospitality client software 34 and to distribute the software 34 for free to Licensed Venture Entity A's customers. The Affiliate B (or Distributee-User/customer E) may include in a database 36 information about its business in the software 34 and may also include information about other affiliates B, if any, and third parties C, D in this component and can include affiliates or third party Bam!S messages in the software 34. For the Licensed Venture Entity A, potential sources of revenue from this component include revenue from others' Bam!S messages, and affiliate marketing and transaction fees, which may be a percentage of the business the affiliates or third parties receive due to their inclusion on the software 34.

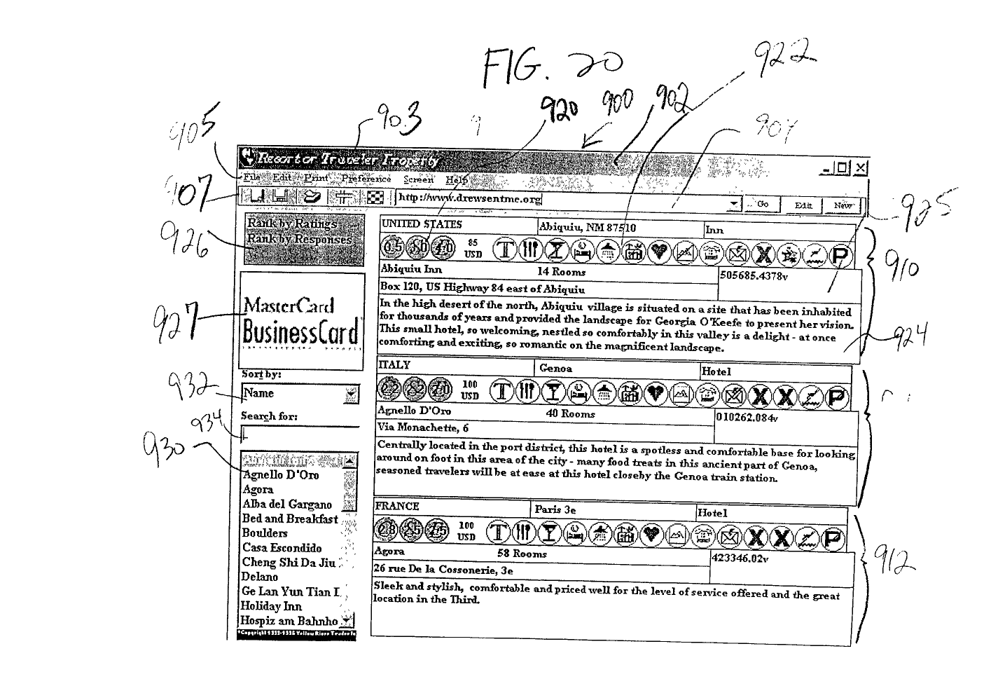

The client hospitality software 34 has a corresponding server version 24. Sample screens from the hospitality client software 34 are shown in FIGS. 20-23, which look similar to the screens shown in FIGS. 4-14. Referring to FIG. 20, screen 900 is a window in a Microsoft® Windows environment having a Title Bar 902, a Menu Bar 905, a Tool Bar 907, a list field 930 for alphabetically listing information in a field or fields (such as a list of establishments, as shown in FIG. 20, or a list of cities, etc.), a Sort selection field 932, a Search field 934, information fields 910-912 for the various selected establishments, a rankings box 926 for ranking the various locations and establishments, and an advertisement field 928. A brand or logo for the Licensed Venture Entity A can appear in the Title Bar 902 at 903. This brand or logo generally appears at all times that the screen is loaded and is on a portion of the screen that is noticeable, yet it does not interfere with viewing of other fields on screen 900.

The user selects a list he wishes to view in field 930 from a pull-down menu in the Sort field 932. For example, in FIG. 20, a sort by establishment name is selected and, hence, the names of establishments appear alphabetically in field 930. If one wished to see establishments in a particular city, one would select to Sort the information in the database by city and then city names would appear in field 930. One may then search for a particular establishment, city or other field by entering a query into the Search field 934. Information for various sites of interests, is shown in multi-field information boxes on 910-912, including name, address (including city and country), typical price range (the displayed currency may be changed by the user), and number of rooms/seats, as appropriate, as well as rating icons 920 for a variety of selected criteria, icons 922 representing various features, such as amenities and services offered (e.g., the availability of drinks, smoking, parking, handicapped accessibility), notes 924 about other related items of interest, and a unique identifier number assigned to each location which can be used to identify the location to enable affiliate and transaction fees to be levied upon the transaction completed by the user identified by the unique user identification.

The establishment selected in field 930 appears first as information box 910 and information for the two establishments that follow alphabetically in the database are included in information boxes 911, 912. An advertisement 927 may appear in box 927.

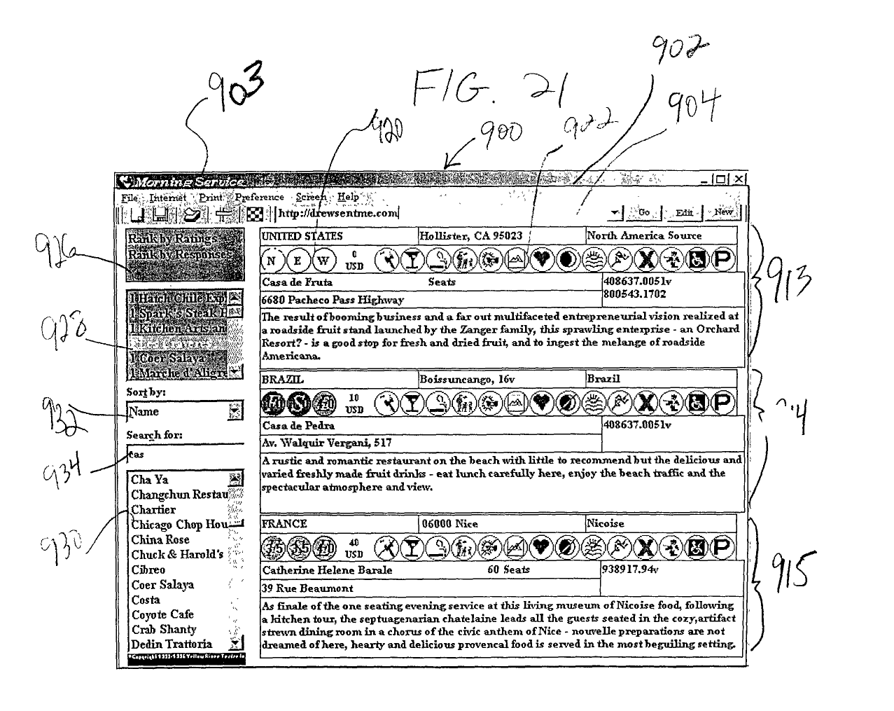

The criteria indicated by icons 920 may include ratings of food, service, and entertainment icons for food establishments and ratings of comfort, service and environment for lodging establishments. New establishments would not have ratings and so would indicate that they are new, as in information box 913 (FIG. 21). Icons 920 and icons 922 may be color coded to deliver a fast overview and reference.

The ranking box 926 provides a ranking of establishments delimited by an amenity offered. To rank establishments by ratings from an official guide, one clicks on the “Rank by Ratings” selection in box 926; to rank establishments by responses from consumers, one clicks on the “Rank by Responses” selection in box 926. For example, this feature can be used to aid in the location of a restaurant with the highest food ratings that offers dancing, or welcomes families, or to locate a lodging with the highest comfort ratings that offers a nearby airport or an Internet connection or telephone line for a computer. In response to the ranking command, advertisement 927 would be hidden and in its place appears a box 928 listing facilities that meet the specified criteria (FIG. 21). Other establishments are listed in information boxes 914, 915.

The Web address of the selected establishment is listed in the Web address field 904. One can thereby make a reservation at the selected establishment by invoking a command to go directly to a Web page where a reservation can be made. A Web address for obtaining more information about an establishment without making any reservation may also be recorded in the database.

The Licensed Venture Entity A and Co- Brand Entity C that provide the hospitality software could be entities like a credit card company for a credit card brand accepted at the various establishments, a bank which issues credit cards, a chain of establishments, or any travel-related entity. Affiliates of the Licensed Venture Entity A and Co- Brand Entity C and third-party advertisers D may contract with Licensed Venture Entity A to include records about their establishments, and goods or services.

In one example of the use of the hospitality software, MasterCard® may wish to encourage consumers to use its brand of credit card while traveling. To this end, it can team up with a publisher of travel publications, such as Conde Nast. Conde Nast may distribute the hospitality client software 34 to readers of its travel publications and both companies Conde Nast and Mastercard® may utilize the software 34 for distributing and playing Bam!S message files 35.

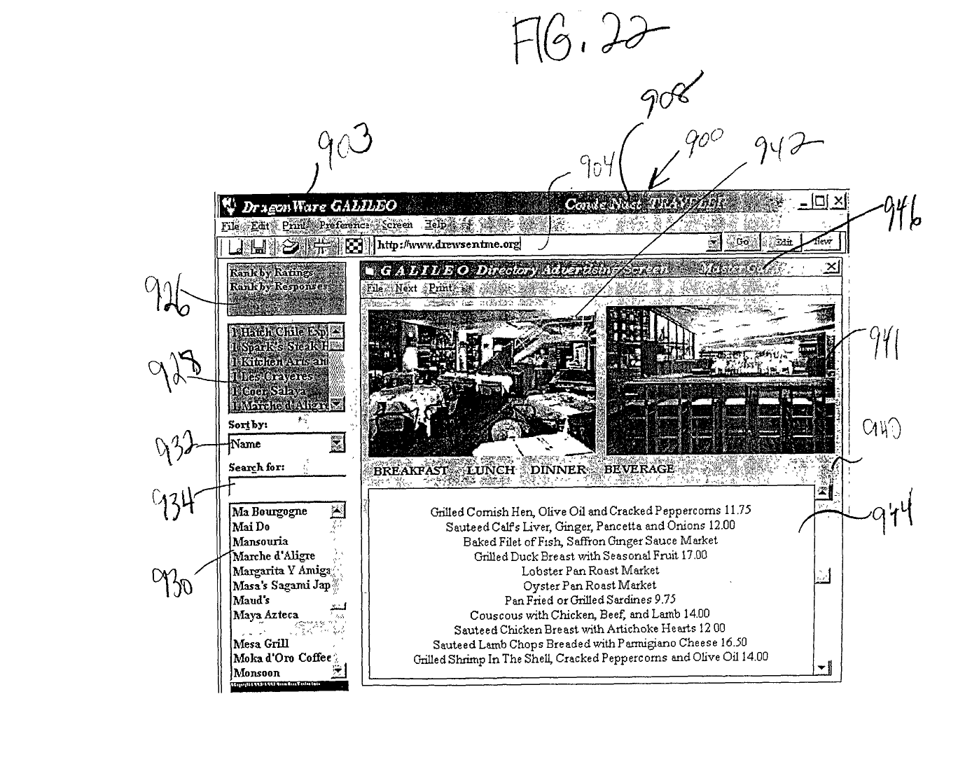

Alternatively, the Co-Brand Entity C or an Affiliate B of the Licensed Venture Entity A could distribute the software. FIG. 22 illustrates this scenario with Conde Nast promoting its Conde Nast TRAVELER® publication at 908 on the Title Bar 902 of screen 900. Meridies restaurant pays for an advertisement to automatically appear on the screen when its name is selected in field 930, before detailed information about its location, ratings, etc., appears on the screen, or for the advertisement to appear by invoking a “View” command. An advertisement window 940 is written to information fields, such as the area where fields 913-915 appear in FIG. 22. The advertisement window 940 shown contains photographs 941, 942 of the interior of the restaurant and a menu 944 but the advertisement window may contain any type of advertisement. MasterCard® may insert its brand name at the top of window 940 at 946.

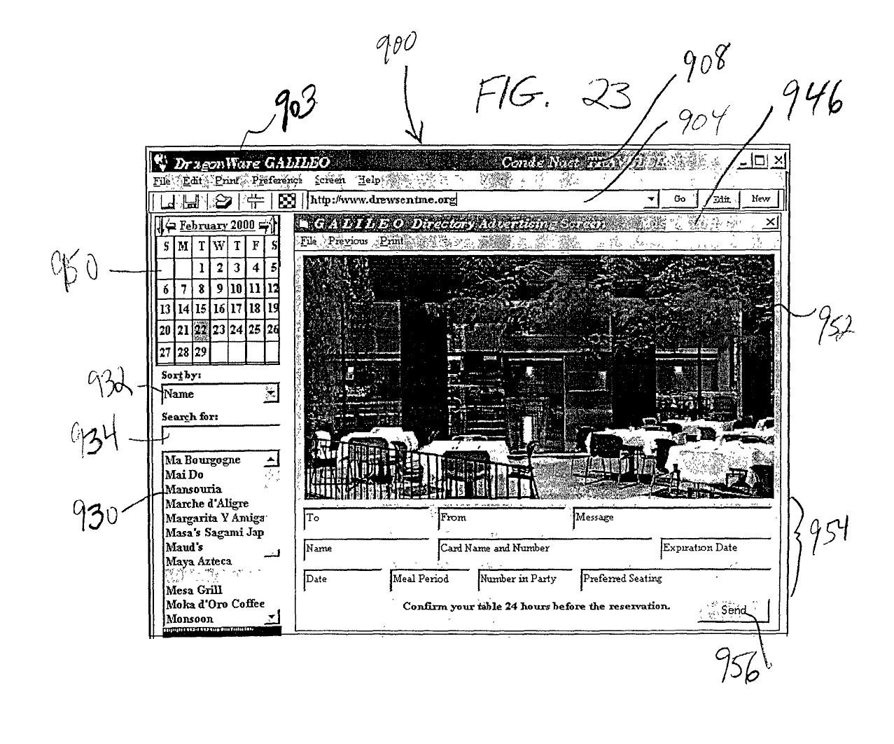

Referring to FIG. 23, a reservation screen 952 (which may be considered a second advertisement screen), also in a window written above screen 900, may contain a single enlarged photograph as well as a set of reservation information fields 954 in which the user may enter the requested information to make a reservation at the selected restaurant using the hospitality client software 34 to connect over the Internet 40. The information is sent over the Internet connection by clicking the Send button 956 at the bottom of the advertisement screen 952. A reservation request entered in screen 952 may be sent directly to the establishment or to a preferred reservations service server. Confirmation is delivered by return email. By sending the reservations from this screen, the parties to the venture may determine any transaction fees contractually due to the Licensed Venture Entity A or any other entity. Alternately appearing in place of the ranking box 926 of FIGS. 20-22 may be a calendar 950 to aid in determining the date for the reservations. MasterCard® is listed in the Title Bar 946 of screen 952 as well.

The hospitality client software 34 may be user-specific like the Bam!S software so that each version of the client uniquely identifies itself to the Venture Server 20.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for distributing at least one of branding, advertising, marketing, and service (BAMS) data from a business entity to electronic devices of a plurality of consumer-users, each of the electronic devices comprising at least a display, a memory, and a processor, the method comprising the steps of:
establishing and maintaining by the business entity a venture server for providing the at least one BAMS data to the plural electronic devices and for controlling usage and display of the at least one BAMS data at the plural electronic devices;
preparing by the business entity a client application capable of being run on the processors of the plural electronic devices, the client application being configured for performing a function that requires a graphical user interface (GUI) to be displayed in the display, for receiving the at least one BAMS data, for storing the at least one BAMS data in the memory, and for displaying the at least one BAMS data in the GUI;
distributing the client application to each of the plurality of consumer-users;
assigning a unique identifier to the client application of each of the plurality of consumer-users;
installing the distributed client application in the electronic devices of the plurality of consumer-users;
establishing a communication link between the at least one venture server and the client application installed in the electronic devices of the plurality of consumer-users; and
distributing via the established communication link the at least one BAMS data to the installed client application in the electronic devices of the plurality of consumer-users.

2. The method as recited in claim 1, wherein each of the plural electronic devices comprises one of a Personal Digital Assistant (PDA), a cellular telephone, a personal computer (PC), and a laptop computer.

3. The method as recited in claim 1, further comprising the step of:
storing records comprising the unique identifier and demographic data of a consumer-user of the installed client application to which the at least one unique identifier was assigned.

4. The method as recited in claim 3, wherein said step of distributing the at least one BAMS data further comprises the step of:
selecting at least one of a consumer-user and a group of consumer-users of the plurality of consumer-users for receiving the at least one BAMS data via the established communication link based on the demographic data in the stored records.

5. The method as recited in claim 3, wherein the demographic data in the stored records comprises zip codes of the plural consumer-users.

6. The method as recited in claim 3, wherein the stored records further comprise data concerning at least one of a product and a service of the business entity, said at least one of a product and a service being utilized by the user.

7. The method as recited in claim 3, further comprising the steps of:
tracking electronic device behavior of individual one of the plural consumer-users using the unique identifier assigned to the installed client application on the electronic devices of the individual users of the plural consumer-users; and
storing the tracked electronic device behavior of the individual ones of the plural consumer-users in the stored records;
wherein the distribution of the at least one BAMS data is optionally based on the tracked electronic device behavior.

8. The method as recited in claim 7, wherein the tracked electronic device behavior of an individual one of the plural consumer-users comprises at least one of usage of the client application, browsing on the World Wide Web (WWW), purchase of articles, application usage of the electronic device, and frequency of usage of the electronic device.

9. The method as recited in claim 1, wherein the unique identifier is hard-coded in the client application.

10. The method as recited in claim 1, wherein the distributed client application is configured to prevent tracking by the client application of electronic device behavior of a consumer-user.

11. The method as recited in claim 1, wherein said step of distributing the client application is performed by an affiliate of the business entity.

12. The method as recited in claim 1, wherein said step of distributing the client application comprises the step of:
mailing to each of the plural consumer-users computer-readable media on which the client application is stored for installation from the computer-readable media to the electronic device of the each consumer-user.

13. The method as recited in claim 12, wherein the computer-readable media mailed to the each consumer-user is accompanied by a product of the business entity.

14. The method as recited in claim 1, wherein the client application comprises an application related to an activity of the business entity.

15. The method as recited in claim 1, wherein the at least one BAMS data comprises a service message from the business entity to at least one of an individual one of the plural consumer-users and a group of the plural consumer-users, said service message comprising information concerning at least one of a service and a product of the business entity, said at least one of a service and a product being utilized by the at least one of an individual one of the plural consumer-users and a group of the plural consumer-users.

16. The method as recited in claim 1, wherein the at least one BAMS data comprises an electronic coupon.

17. A method for distributing at least one of branding, advertising, marketing, and service (BAMS) data from a business entity to electronic devices of a plurality of consumer-users, each of the electronic devices comprising at least a display, a memory, and a processor, the method comprising the steps of:
establishing and maintaining by the business entity a venture server for providing the at least one BAMS data to the plural electronic devices and for controlling usage and display of the at least one BAMS data at the plural electronic devices;
preparing by the business entity a client application capable of being run on the processors of the plural electronic devices, the client application being configured for performing a function that requires a graphical user interface (GUI) to be displayed in the display, for receiving the at least one BAMS data, for storing the at least one BAMS data in the memory, and for displaying the at least one BAMS data in the GUI;
distributing to each of the plural consumer-users computer-readable media on which the client application is stored for installation from the computer-readable media to the electronic device of the each of the plural consumer-users;
storing records each comprising at least one of a unique identifier, demographic data of particular one of the plural consumer-users of the client application to which the unique identifier was assigned, and consumer data concerning at least one of a product and a service of the business entity, said at least one of a product and a service optionally being utilized by the particular one of the plural consumer-users;
installing from the distributed computer-readable media the client application in the electronic devices of the plurality of consumer-users;
establishing a communication link between the venture server and the installed client applications in the electronic devices of the plurality of consumer-users; and
distributing by the business entity via the established communication link the at least one BAMS data to the installed client application in the electronic devices of the plurality of consumer-users;
wherein the business entity optionally selects at least one of one of the plural consumer-users and a group of the plural consumer-users for receiving the at least one BAMS data based on the data in the stored records.

18. The method as recited in claim 17, wherein each of the electronic devices comprises one of a Personal Digital Assistant (PDA), a cellular telephone, a personal computer (PC), and a laptop computer.

19. The method as recited in claim 17, further comprising the steps of:
tracking electronic device behavior of individual ones of the plural consumer-users using the unique identifier assigned to the installed client application on the electronic devices of the plurality of consumer-users; and
storing in the stored records data regarding the tracked electronic device behavior of the individual ones of the plural consumer-users.

20. The method as recited in claim 19, wherein the tracked electronic device behavior of an individual one of the plural consumer-users comprises at least one of usage of the client application, browsing on the World Wide Web (WWW), purchase of items, application usage of the electronic device, and frequency of usage of the electronic device by the individual one of the plural consumer-users.

21. The method as recited in claim 17, wherein said step of distributing the client application is performed by an affiliate of the business entity, the distributed computer-readable media is accompanied by a product of the business entity, and the client application comprises an application related to an activity of the business entity.

22. A system for distributing at least one of branding, advertising, marketing, and service (BAMS) data from a business entity to a plurality of consumer-users, the system comprising:
a venture server established and maintained by the business entity for providing the at least one BAMS data and for controlling usage and display of the at least one BAMS data;
a plurality of electronic devices for the plurality of consumer-users, each of said electronic devices comprising at least a display, a memory, and a processor capable of running a client application, wherein the client application is configured for performing a function that requires a graphical user interface (GUI) to be displayed in the display, for receiving the at least one BAMS data from the venture server, for storing the at least one BAMS data in the memory, and for displaying the at least one BAMS data in the GUI; and
a network for establishing at least one communication link between the venture server and the plurality of electronic devices;
wherein a unique identifier is assigned to a client application installed in an individual one of the plurality of electronic devices.

23. The system as recited in claim 22, wherein each of the plural electronic devices comprises one of a Personal Digital Assistant (PDA), a cellular telephone, a personal computer (PC), and a laptop computer.

24. The system as recited in claim 22, further comprising:
a database for storing records comprising the unique identifier and demographic data of a consumer-user of the installed client application to which the unique identifier was assigned.

25. The system as recited in claim 22, wherein the venture server provides the at least one BAMS data by selecting at least one of a consumer-user and a group of consumer-users of the plural consumer-users for receiving the at least one BAMS data via the at least one communication link based on the demographic data in the database records.

26. The system as recited in claim 22, wherein the demographic data in the database records comprises zip codes of the plural consumer-users.

27. The system as recited in claim 22, wherein the database records further comprise data concerning at least one of a product and a service of the business entity, said at least one of a product and a service being utilized by the user.

28. The system as recited in claim 22, wherein the system tracks electronic device behavior of individual ones of the plural consumer-users using the unique identifier assigned to the installed client application on the electronic devices of the individual ones of the plural consumer-users, stores the tracked electronic device behavior of the individual ones of the plural consumer-users in the database records, and optionally distributes the at least one BAMS data based on the tracked electronic device behavior.

29. The system as recited in claim 28, wherein the tracked electronic device behavior of an individual one of the plural consumer-users comprises at least one of usage of the client application, browsing on the World Wide Web (WWW), purchase of articles, application usage of the electronic device, and frequency of usage of the electronic device.

30. The system as recited in claim 22, wherein the unique identifier is hard-coded in the client application.

31. The system as recited in claim 22, wherein the at least one client application is configured to prevent tracking by the client application of electronic device behavior of a consumer-user.

32. The system as recited in claim 22, wherein the network comprises at least one of the Internet, a telephone system, a wireless system, and a cable broadcast system.

33. The system as recited in claim 22, wherein the client application is distributed to the plurality of consumer-users by mailing to each of the plural consumer-users computer-readable media on which the client application is stored for installation from the computer-readable media to the electronic device of the each consumer-user.

34. The system as recited in claim 33, wherein the computer-readable media is mailed to the each consumer-user accompanied by a product of the business entity.

35. The method as recited in claim 22, wherein the client application comprises an application related to an activity of the business entity.

36. The method as recited in claim 22, wherein the at least one BAMS data comprises a service message from the business entity to at least one of an individual one of the plural consumer-users and a group of the plural consumer-users, said service message comprising information concerning at least one of a service and a product of the business entity, said at least one of a service and a product being utilized by the at least one of an individual one of the plural consumer-users and a group of the plural consumer-users.

37. The method as recited in claim 22, wherein the at least one BAMS data comprises an electronic coupon.

38. A system for distributing at least one of branding, advertising, marketing, and service (BAMS) data from a business entity to a plurality of consumer-users, the system comprising:
a venture server established and maintained by the business entity for providing the at least one BAMS data and for controlling usage and display of the at least one BAMS data;
a plurality of electronic devices for the plurality of consumer-users, each of said electronic devices comprising at least a display, a memory, and a processor capable of running a client application, wherein the client application is configured for performing a function that requires a graphical user interface (GUI) to be displayed in the display, for receiving the at least one BAMS data from the at least one venture server, for storing the at least one BAMS data in the memory, and for displaying the at least one BAMS data in the GUI;
a database for storing records each comprising at least one of a unique identifier, demographic data of a particular one of the plural consumer-users of the client application to which the unique identifier was assigned, and consumer data concerning at least one of a product and a service of the business entity, said at least one of a product and a service optionally being utilized by the particular one of the plural consumer-users; and
a network for establishing at least one communication link between the venture server and the plurality of electronic devices;
wherein the business entity optionally selects at least one of one of the plural consumer-users and a group of the plural consumer-users for receiving the at least one BAMS data based on the data in the stored records.

39. The system as recited in claim 38, wherein each of the electronic devices comprises one of a Personal Digital Assistant (PDA), a cellular telephone, a personal computer (PC), and a laptop computer.

40. The system as recited in claim 38, wherein the system tracks electronic device behavior of individual ones of the plural consumer-users using the unique identifier assigned to individual ones of client applications installed on the electronic devices of the individual ones of the plural consumer-users, and stores in the database records data regarding the tracked electronic device behavior of the individual ones of the plural consumer-users.

41. The system as recited in claim 40, wherein the electronic device behavior of an individual one of the plural consumer-users comprises at least one of usage of the client application, browsing on the World Wide Web (WWW), purchase of items, application usage of the electronic device, and frequency of usage of the electronic device by the individual one of the plural consumer-users.

42. The system as recited in claim 38, wherein an affiliate of the business entity distributes the client application on computer-readable media accompanied by a product of the business entity and the client application comprises an application related to an activity of the business entity.
